(19) United States
(12) Patent Application Publication
(10) Pub. No.: US 2008/0283109 A1
(43) Pub. Date: Nov. 20, 2008

(54) Space solar power system for thermochemical processing and electricity production

(76) Inventors: John Carlton Mankins, Ashburn, VA (US); Robert Stottle Wegeng, Richland, WA (US)

Correspondence Address: John C Mankins, 43446 Thistlewood Court, Ashburn, VA, 20147, US

(21) Appl. No.: 12/009,733

(22) Filed: Jan. 22, 2008

Related U.S. Application Data
(60) Provisional application No. 60/881,689, filed on Jan. 22, 2007.

(51) Int. Cl. H01L 35/02; H01L 35/34

(52) U.S. Cl. 136/206; 136/201

(57) ABSTRACT

Thermochemical processing systems for the production of electricity and chemicals using energy from an orbiting space solar power satellite (100). Methods of producing electricity and chemicals using the powerbeam (120). Systems and applications include the orbiting satellite, which intercepts solar energy (110) and directs a powerbeam to a lunar or planetary surface or a receiving system in space; rectennas (220) for the production of electricity; and concentrators (300), receivers (310) and thermochemical process systems for the production of fuels and other chemicals. Efforts are made to optimize the operation of the system through the utilization of solar energy, when available, plus the powerbeam from the satellite.

### CROSS-REFERENCE TO RELATED APPLICATIONS

This invention claims the benefit of provisional patent application Ser. No. 60/881,689, filed 2007 Jan. 22 by the present inventors.

### FEDERALLY SPONSORED RESEARCH

In accordance with 37 CFR 501, the inventions described herein may be manufactured and used by or for the United States Government for governmental purposes without the payment of any royalties thereon or therefor.

### SEQUENCE LISTING OF PROGRAM

Not applicable

### FIELD OF THE INVENTIONS

These inventions relate to the concentration and conversion of solar and other forms of radiant energy into chemical energy and the production of chemical products using radiant energy.

### BACKGROUND OF THE INVENTION

There is a need for space systems that can convert radiant energy to chemical energy with high efficiencies. Transporting consumable products along with humans (and robotic systems) from Earth into space is expensive. Accordingly, to conduct exploration or other activities in space, there is a need for the inexpensive provision of consumable chemicals, based on indigenous space resources, including oxygen for breathing and propellants for transportation, on space bodies. However, the production of chemical products typically requires an energy input. In the case where a thermochemical process is applied, basic thermodynamics dictates that the energy efficiency of the process will be directly proportional to the peak temperature of the operation (i.e., thermochemical processes follow the same thermodynamics rules as heat engines). Since solar energy is available in space, but in a relatively unconcentrated form, there is a need for the integration of endothermic chemical processors with solar and other radiant energy concentrators to obtain high operating temperatures and high energy efficiencies.

In some cases, such as on the lunar surface, lengthy diurnal periods can cause direct solar energy to be unavailable for days (or weeks) at a time. There are also areas, such as in craters near the poles of the Moon, that are in more or less permanent darkness. One way to provide for greater operational effectiveness is to direct, or redirect, solar or other radiant energy to systems operating in a shadowed area.

Accordingly, there is a need for orbiting and ground-based systems that can provide solar or other radiant energy to the remotely located receiver systems.

There is also a need on Earth for systems that can convert radiant energy into chemical energy with high efficiencies. Over the past several hundred years, fossil fuel materials have been the chemical feedstock of choice for many energy conversion systems as well as for the production of useful chemicals. As examples, coal, oil and natural gas are routinely combusted in thermal powerplants for the production of electricity; oil is refined for the production of gasoline and other transportation fuels; natural gas is used as a chemical feedstock for the production of hydrogen and other chemicals; and synthesis gas, which can be made from fossil fuels (or non-fossil feedstocks), is a commonly used precursor material for many useful chemical products, including hydrogen, alcohols and other hydrocarbons, and ammonia.

However, fossil fuels represent a finite, limited energy resource and their combustion produces greenhouse gases and toxic substances. There is growing concern that fossil fuels, as an energy source and as a chemical feedstock, will have to be replaced by alternative energy sources.

Solar energy, plentiful on Earth and in space, is a potential alternative energy source for the production of chemicals. However, it is somewhat diffuse and is intermittent (on Earth and other planetary bodies). Accordingly, there is a need for energy conversion systems that can compensate for these apparent shortcomings and effectively make use of solar energy for the production of high-energy density chemical fuels and other chemicals.

### SUMMARY OF THE INVENTION

In one aspect, the present invention is a space solar power system, comprising a transmitter, a concentrator, a radiant energy receiver further comprising a heat exchanger, where a powerbeam is directed from the transmitter to the concentrator, which intensifies and directs the powerbeam to the radiant energy receiver, which converts the powerbeam into heat and produces an increase in the energy content of a fluid. The heat exchanger may be a microchannel heat exchanger and may incorporate a catalyst for an endothermic reaction and the powerbeam may be laser energy, microwaves or other radiant energy.

In another aspect, the invention is a space solar power system comprising a powersat, producing a powerbeam; a first plurality of surface structures on a lunar or planetary surface, further comprising receivers for the production of electricity; a second plurality of surface structures on the lunar or planetary surface further comprising concentrators and receivers for increasing the chemical energy content of a reacting fluid through an endothermic chemical reaction; and means to adjust the powerbeam to vary the surface flux at the first plurality of surface structures and the second plurality of surface structures.

In yet another aspect, the invention is a method of operating a space solar power system comprising a first step of directing a powerbeam from a transmitter to a first portion of a surface installation and producing electricity while using solar energy to perform a thermochemical process in a second portion of the surface installation, and adjusting the powerbeam to provide radiant energy to the second portion of the surface installation therefore providing powerbeam energy for the thermochemical process.

In another aspect, the invention is a method of operating a radiant energy concentrator comprising aligning the concentrator with and receiving radiant energy from a first source of radiant energy, directing intensified radiant energy into a receiver, converting it to heat, and performing an endothermic chemical reaction; and aligning the concentrator with and receiving radiant energy from a second source of radiant energy, directing intensified radiant energy into the receiver, converting it to heat, and performing the endothermic chemical reaction. One of the sources of radiant energy may be the sun and another source may be a powersat.

The subject matter of the present invention is particularly pointed out and distinctly claimed in the concluding portion of this specification. However, both the organization and method of operation, together with further advantages and objects thereof, may best be understood by reference to the description taken in connection with accompanying drawings.

### GLOSSARY

A “solar chemical” is 1) a single- or multi-component substance that has been thermochemically processed in such a way that solar energy has provided a substantial portion of the inherent chemical energy of the substance or 2) a single- or multi-component substance that has been thermochemically processed using solar energy in substantial measure to produce the substance. Examples of the former include synthesis gas or other chemical products that were produced from synthesis gas (such as hydrogen, alcohols, other hydrocarbons or ammonia) where the synthesis gas was produced through a solar-heated thermochemical process that used natural gas, biomass-derived feedstocks, or zero-energy chemicals such as water and carbon dioxide. Examples of the latter include the products of solar-heated distillation or other solar-heated thermochemical separation processes that separate but do not necessarily add chemical energy to the products of that process. A solar chemical may be a solid, liquid or gas.

A “solar fuel” is a solar chemical that may typically, but not exclusively, be used for the production of heat or electricity or other forms of work, such as to propel an automobile.

“Radiant energy” is energy traveling in the form of electromagnetic waves, such as solar energy, laser energy, thermal infrared energy, microwave energy, or any other energy in the form of photons.

A “radiant energy transmitter”, or “transmitter”, is a surface system or an orbiting satellite or other spacecraft that emits photons. The photons comprising the radiant energy may be of various wavelengths, including microwaves or visible light laser energy. The transmitter may direct radiant energy to a radiant energy receiver. Note that, when used herein, we do not intend to use the term radiant energy transmitter to include the sun.

A “space solar power satellite”, or “powersat”, is a spacecraft that intercepts solar energy or other radiant energy and produces, reflects, or otherwise directs a powerbeam to a radiant energy receiver on the surface of a lunar or planetary body or elsewhere in space, such as to another spacecraft. Note that, while the common use of the word “satellite” connotes an object orbiting Earth, when used herein we intend the terms “satellite” and “powersat” to include spacecraft that are not in an orbit. Also note that, herein, we include Earth as a member of the group of lunar or planetary bodies.

A “radiant energy concentrator”, or “concentrator”, is a system that converts a radiant energy beam from one power intensity (e.g., as measured in watts/m²) to a higher power intensity, such as a segmented-mirror concentrator, a central receiver system, a parabolic trough concentrator, a fresnel lens, an assembly of fiber optics, or another system that intensifies the radiant energy from a radiant energy transmitter, the sun, or any other source of photons. The concentrator may direct the radiant energy to a radiant energy receiver.

A “hybrid concentrator” is a concentrator that has been designed with specific features that support the intensification of multiple classes of radiant energy. For example, microwave energy and solar energy.

A “radiant energy receiver”, or “receiver”, is a system that absorbs solar or other radiant energy. Radiant energy that is absorbed by the receiver may have been intensified and directed to the receiver by a concentrator. In some applications, the heat that is produced may be used to drive an endothermic chemical reaction or a separation. A rectifying antenna (also called “rectenna), for the absorption and conversion of microwave energy into electricity is an example of one type of receiver.

A “thermal energy receiver” or “thermal receiver” is a radiant energy receiver that is designed to absorb and convert radiant energy into heat. For example, a thermal receiver may produce heat to drive a thermal powerplant or a thermochemical process system.

A “hybrid thermal receiver” is a thermal receiver that absorbs, simultaneously or at different times, energy from both a radiant energy source and another source, such as an internal combustor or an electrical resistance heater.

A “thermochemical processing system” is a network of components, individually performing chemical process unit operations such as chemical reactions, separations, heat exchange, pumping, compressing and valving, and operated collectively for the purpose of producing one or more useful chemicals. At least one of the unit operations involves the exchange of heat.

A “microchannel” is a channel having at least one dimension that is about 2 millimeters or less, preferably 1 millimeter or less. The length of a microchannel is defined as the furthest direction a fluid could flow, during normal operation, between the entrance and exit of the microchannel. The width and depth are perpendicular to length, and to each other, and in the illustrated embodiments, width is the smaller of the two.

A “microchannel heat exchanger” is a heat exchanger incorporating at least one microchannel, through which a fluid flows that is being heated or giving up heat, plus a means for fluid entrance to (e.g., a “header”) and exit from (e.g., a “footer”) the microchannel. A microchannel heat exchanger may be incorporated within a chemical reactor or a chemical separator.

A “microchannel reactor” is a chemical reactor incorporating at least one microchannel, plus a means for fluid entrance to (e.g., a “header”) and exit from (e.g., a “footer”) the microchannel. A microchannel reactor may be a microchannel heat exchanger that has been designed to support a thermochemical reaction; for example, to support a reaction involving heteorogeneous catalysis, a solid catalyst may be coated to the walls of the microchannels, placed within as an insert, or otherwise incorporated within the microchannel heat exchanger.

The “thermochemical efficiency” of a thermochemical reactor or a thermochemical process system is the ratio of the net increase in the chemical energy of the chemically reacting stream (i.e., the chemical energy of the products minus the chemical energy of the reactants) to the thermal energy input. When expressed in percentages, the ratio is multiplied by 100%. In accordance with rules of thermodynamics, the Carnot Cycle efficiency is an approximate upper bound for the thermochemical efficiency of an endothermically reacting system.

An “absorption enhancement” is an element of a thermal receiver and increases the ability of the receiver to absorb radiant energy and convert it to heat. As examples, absorptive coatings, susceptor materials and cone reflectors can increase the absorption of microwave photons—therefore reducing the flux of microwaves that are reflected out of a thermal receiver cavity—are therefore absorption enhancements.

### BRIEF DESCRIPTION OF THE DRAWINGS

FIG. 1a is an illustration of a powersat directing a powerbeam to a receiver at the surface of a lunar or planetary body.

FIGS. 1b and 1c depict the operation of an assembly of radiant energy concentrators that track and receive radiant energy from the sun and a powersat.

FIG. 2a provides cross-sectional illustrations of the energy flux of a powerbeam in two modes; one mode depicts operation of a powersat so that the majority of the energy of the powerbeam is directed to the central portion of a ground receiving facility and the other mode depicts operation of the powersat so that a substantial portion of the energy of the powerbeam is directed to a region surrounding the central portion of the ground receiving facility. FIG. 2b identifies the central and surrounding portions of the ground receiving facility.

FIG. 3 depicts a segmented-mirror, parabolic dish concentrator with a thermal receiver at its' focal point.

FIG. 4 depicts a view of the reflecting portion of a hybrid concentrator, capable of concentrating solar and microwave energy.

FIGS. 5a, 5b, 5c, 5d and 6 provide chemical process diagrams for a portion of a thermochemical process network where radiant energy is used to drive endothermic unit operations.

FIG. 7 provides a tabular listing of example thermochemical reactions for producing solar fuels from chemical feedstock materials.

FIGS. 8a and 8b provide cross-sectional and side views of three cylinders that, once assembled, make up a part of a thermal receiver for chemical processing.

FIG. 9 provides an expanded view of a sectional from FIG. 8b depicting microchannels, for heat exchanger and/or chemical reactions, within the innermost cylinder of a thermal receiver.

FIGS. 10a and 10b depict manifolds and slots for electrical resistance heaters in the central-most and outermost cylinders of a thermal receiver for thermochemical processing.

FIG. 11 provides an alternative design for the innermost cylinder of a thermal receiver for thermochemical processing where raised surfaces separate individual microchannel reactors.

FIG. 12a provides an expanded view of a sectional from FIG. 11, depicting raised surfaces along with microchannels and microchannel reactors.

FIG. 12b provides an exploded view of a portion of a thermal receiver for thermochemical processing, highlighting the three cylinders and including individual microchannels, raised surfaces, a porous insert for a combustion catalyst, and the slot for an electrical resistance heater.

FIG. 13a depicts an alternative design of the innermost cylinder of a thermal receiver for thermochemical processing where thermally-conductive porous inserts, themselves containing catalyst materials, replace the microchannels.

FIG. 13b provides an exploded view of a portion of a thermal receiver for thermochemical processing based upon the concept of FIG. 13a, further depicting the use of a thermally-conductive porous insert. This version is for an embodiment that does not incorporate combustion and therefore requires only the innermost and outermost cylinders for the thermal receiver. Also shown is a slot for electrical resistance heating.

FIGS. 14a and 14b depict thermal receiver cavities incorporating absorption enhancements.

FIGS. 15a and 15c illustrate multiple reflections of radiant energy entering and propagating within a thermal receiver cavity, for one specific angle of entrance (equal to the initial angle of reflection), for cases without and with the use of a cone reflector as an absorption enhancement.

FIG. 15c depicts a thermal receiver cavity that incorporate both susceptor materials and a cone reflector.

FIG. 16 provides a partially exploded, graphical representation of the fluid flow within a thermal receiver for thermochemical processing, including manifolds and reaction, heat exchange and combustion zones.

FIG. 17 provides an exploded view of the primary components of a thermal receiver for thermochemical processing.

FIG. 18 provides a diagram illustrating the steps associated with making a thermal receiver for thermochemical processing.

FIG. 19 provides a tabular listing of preliminary performance calculations for a collection of thermal receivers for thermochemical processing based on intercepting 1.0 GWᵣ (gigawatts of radiant energy).

### UST OF REFERENCE NUMERALS

100 powersat
110 solar energy
120 powerbeam
130 ground receiving facility
140 lunar or planetary surface
150 photovoltaic cell array(s)
160 transmitter
170 collection of radiant energy concentrators
200 cross-section of powerbeam flux for one mode of powersat operation
210 cross-section of powerbeam flux for another mode of powersat operation
220 rectifying antenna system
300 parabolic, segmented-mirror concentrator
310 thermal receiver
320 mirror segment
400 hybrid concentrator dish
410 concentrator segment for reflecting/intensifying solar, laser and microwave radiant energy
420 mesh concentrator segment for reflecting/intensifying microwave radiant energy
800 first (innermost) cylinder of a thermal receiver
810 second (central) cylinder of a thermal receiver
820 third (outermost) cylinder of a thermal receiver
900 microchannels
1000 manifolding channels including headers and footers
1010 slot for electrical resistance heaters
1100 raised surfaces
1110 reaction zones
1200 channel
1210 porous catalyst insert
1300 thermally-conductive porous catalyst insert for endothermic reaction
1400 susceptor material/disc
1410 cavity endpiece
1420 cone reflector
1600 heat exchanger zone
1610 combustion zone
1700 quartz window
1710 aperture

### DETAILED DESCRIPTION

### Purpose, Description and Functional Operation of Innovations

The purpose of the inventions described herein is to use solar or other radiant energy as an energy input to the thermochemical production of propellants, fuels, and other useful chemicals. Chemical feedstocks for the process can be of space or terrestrial origin.

### Component Parts

### Radiant Energy Transmitter

The radiant energy transmitter may be a system on a lunar or planetary surface, including Earth, or a system in space. For example, the transmitter may be located on the rim of a permanently-shadowed crater that is near the North or South poles of the Moon, where it can be used to beam power to a radiant energy receiver in the crater. In this case, the transmitter may receive energy from any of a number of sources, such as from solar power, nuclear power reactors, stored chemical or thermal energy, or others.

Alternately, transmitters may be located in space, such as onboard an orbiting spacecraft. The spacecraft may be in a fixed location relative to the surface (e.g., in a geostationary orbit or at a Langrangian Point), or it may be in motion relative to the surface. Preferably, the source of energy for a transmitter located in space is solar energy. See U.S. Pat. No. 3,781,647, Glaser, P., “Method and apparatus for converting solar radiation to electrical power”, 1973.

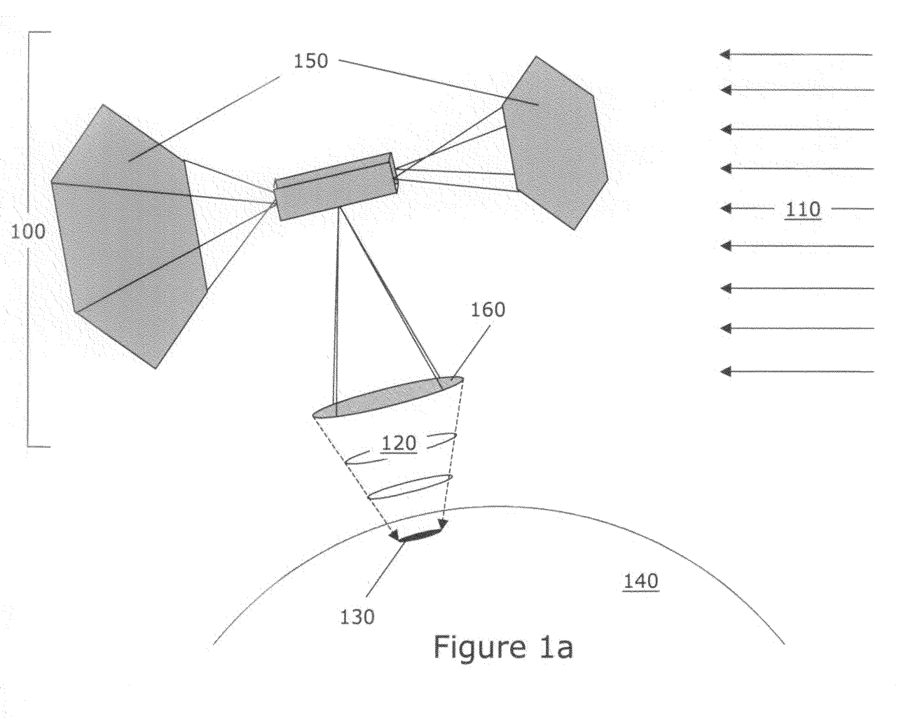

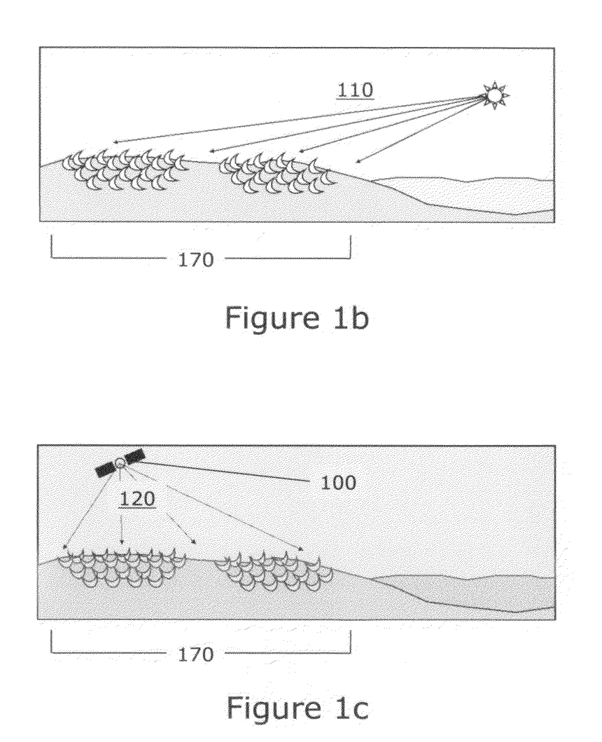

FIG. 1a illustrates the general concept for a powersat 100 that intercepts solar energy 110 and directs a powerbeam 120 to another spacecraft or to a facility 130 on the surface of a lunar or planetary body 140. The preferred process onboard the powersat includes a first step of converting solar photons to electricity and a subsequent step of converting the electricity to a powerbeam consisting of photons at a suitable frequency for transmission through the atmosphere. Preferably, the solar energy is converted to electrical energy onboard the powersat using thin-film or crystalline photovoltaic systems 150 and the powerbeam consists of photons—produced by a phase array transmitter 160 at wavelengths in the atmosphere's so-called “microwave window”, which is a range running from about 1 centimeter to about 10 meters. As examples, we note that studies investigating space solar power typically assume that the powerbeam will be at a wavelength of either about 12.2 centimeters or about 5.2 centimeters, which correspond to frequencies, respectively, of about 2.45 and 5.8 GHz, which are each bands that are designated for industrial, scientific and medical usage and for that reason are unregulated.

While alternatives for the first step could include generating electricity via systems such as Brayton or Stirling Cycle heat engines, these are not preferred as they require large, massive radiator structures since, as heat engines, they are required by the Second Law of Thermodynamics to reject waste heat. Their thermal efficiencies are also constrained by heat rejection limitations in space, where the lack of a convective heat transfer medium typically makes it necessary to reject heat at medium- to high-temperatures in order to reduce the mass of the radiators. Photovoltaics, while also being subject to the Second Law of Thermodynamics, are not heat engines and are well-known to be preferred for power generation when solar energy is sufficiently intense, such as in Earth orbit or elsewhere in the inner portion of the solar system.

Similarly, non-microwave powerbeams are alternatives, such as might be provided through the use of visible-light lasers which produce photons at wavelengths that can pass through the atmosphere's so-called “visible window”, or millimeter waves such as can be produced by klystrons or gyrotrons. Neither lasers nor millimeter waves are preferred, however, in part because they are not as efficient as phased array microwave transmitters. Transmitters based on lasers or millimeter waves will therefore require greater amounts of solar energy to be intercepted plus the associated mass of additional photovoltaic systems, in part because microwaves can be more efficiently converted to useful energy by ground facilities. In particular, we note that microwaves can efficiently be converted to electricity by rectifying antennas.

The net conversion efficiency, from electricity in-orbit to electricity on the ground, based on the use of phased-array microwave generators and ground rectennas, is expected to be at least 50% and perhaps as high as about 60%-65% or greater. With visible light lasers in orbit and photovoltaic systems on the ground, the corresponding conversion efficiency, from electricity in-orbit to electricity on the ground, would likely be no more than about half of the efficiency of the microwave-based system. This has a substantial effect on the amount of solar energy that would have to be intercepted by the powersat, the heat that the powersat would have to reject, and therefore the overall size and mass of the powersat. In addition, we will see in following sections that microwaves can also be efficiently used by concentrating radiant energy systems for the thermochemical production of fuels and other chemicals.

FIGS. 1b and 1c illustrate the operation of a space solar power satellite for thermochemical processing. When direct sunlight is available, as shown in FIG. 1b, concentrators 170 receive solar energy 110 from the sun and convert it, through thermochemical processes, to chemical energy. When direct sunlight is not available to the concentrators, as shown in FIG. 1c, the concentrators 170 track and point at the powersat 100, receiving and intensifying radiant energy 120 for use in the thermochemical process. Operation in this manner improves the overall productivity of the ground facility since it is able to make use of free energy from the sun.

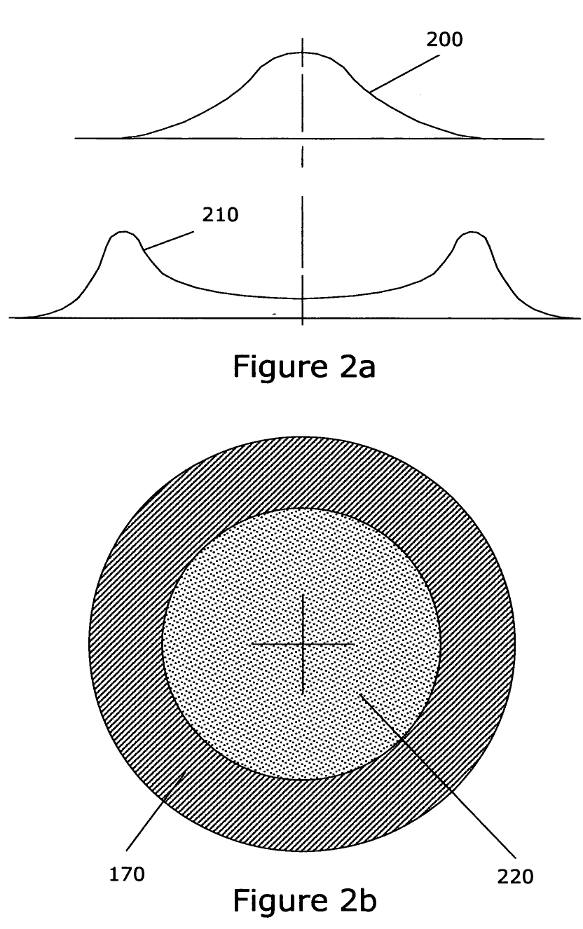

One way to facilitate thermochemical processing in conjunction with electricity production, as suggested in FIGS. 2a and 2b, is to place rectennas 220 and thermochemical processors 170 in close proximity on the ground. In this case it is preferable to direct the powerbeam to area of the thermochemical process system only when the sun is not available; otherwise, when the concentrators associated with the thermochemical process are pointed at the sun, they would not be making use of the energy in the powerbeam. This is accomplished by shifting the shape of the powerbeam.

More generally, in order to achieve maximum end-to-end power transmission efficiency using a powerbeam, a cross-sectional energy density in the shape of a Gaussian distribution is required in what is known as the “main lobe” of the electromagnetic beam, as shown in FIG. 2a. A typical Gaussian distribution is one in which the intensity (watts/m²) at the center of the powerbeam is ten-times greater than the intensity at the edge of the powerbeam. Even when using a Gaussian distribution, however, some of the transmitted energy goes into any one of a larger number of “side lobes” that are spatially distributed around the main lobe. A main lobe in the shape of a Gaussian at the receiver may be formed by transmitting a powerbeam in the shape of the Gaussian from a circular transmitting antenna. However, a variety of other, less optimal powerbeam shapes may also be formed using various methods. For example, one method for forming a powerbeam with a different cross-sectional energy distribution is to use a non-circular transmitter.

It is also possible to configure the transmitter antenna so at to allow the cross-sectional energy density of the powerbeam being emitted from an antenna of a fixed physical geometry to be varied. Such changes in the distribution of electromagnetic energy of the powerbeam being received from an antenna of fixed geometry can be produced by varying the energy density from individual antenna elements of the transmitter. Engineering changes in the shape of the powerbeam being transmitted results in turn in corresponding changes in the shape of the powerbeam at the receiver. For example, as noted above, generating a powerbeam in the shape of a Gaussian distribution at the transmitter produces a main lobe that is also in the shape of a Gaussian distribution.

During periods of time when maximum economic value is obtained by using a transmitted beam of radiant energy to generate electrical power, the powerbeam would preferably be emitted in the form of a Gaussian distribution—see FIG. 2a—with the main lobe 200 of the transmitted energy arriving in the form of a Gaussian distribution at the receiving antenna. However, during periods of time when the powerbeam might be used more to achieve greater economic value in an alternate fashion, the shape of the received powerbeam on the ground may be moved to another location, altered in shape or otherwise changed by varying the energy being emitted by the individual elements of the transmitter in a controlled manner. In order to achieve this functionality, it is necessary that the powerbeam-generating devices at the transmitter be capable of being operated in a precisely controlled way at a number of different power output levels. FIG. 2a also illustrates a revised shape for the powerbeam 210 where a greater amount of energy is delivered in an annular region around the perimeter of the center of the powerbeam.

As shown in FIG. 2b, one physical configuration for this type of receiving site would be as follows: A physically contiguous rectenna 220 (to be used in the generation of electrical power) is placed at the center of the ground facilities, and one or more concentrator systems 170 are placed around the edge of this centrally-located rectenna, to be used to provide radiant energy for thermochemical processing or other purposes. For example, during mid-afternoon when demand for electricity is greatest, and/or when sunlight is available for thermochemical processing, the powerbeam from the transmitter may be delivered to the central rectenna; then, during nighttime hours when the demand for electricity is reduced, the beam may be re-shaped by adjusting the power output from individual transmitter elements with a substantial portion of the total radiant energy being delivered to the thermochemical processing system.

### Radiant Energy Concentrator

The purpose of the radiant energy concentrator is to transform radiant energy from the transmitter, from the sun, or from another source, into a more intense powerbeam. Where the concentrator is operated in concert with a thermal receiver, it allows the receiver to produce heat at a moderate to high temperature.

In previous years, governments and industry have invested in the development of multiple types of concentrators, including parabolic dish mirror units, parabolic segmented-mirror dish units, linear- and point-focus Fresnel lenses, parabolic trough mirror concentrators, solar furnaces, solar bowls and central receivers and central receiver towers with beam-down optics. See Duffle, J. and W. Beckman, “Solar Engineering of Thermal Processes,” Wiley, 2006; Cassedy, E., “Prospects for Sustainable Energy—A Critical Assessment”, Cambridge University Press, 2000; Goswani, D. and F. Kreith (eds), “Energy Conversion”, CRC Press, 2008; and Segal, A. and M. Epstein, “Solar Ground Reformer”, Solar Energy 75 (2003) 479-490. Common applications have ranged from the production of hot water to producing electricity via a Stirling Cyde heat engine.

For Mars and the Moon, since gravity is less than on Earth, structural loads are reduced. In addition, on the Moon there is no wind loading. Accordingly, a concentrator structure on the lunar surface might be substantially less massive than a concentrator structure designed for terrestrial applications. For example, a lunar concentrator may consist of a thin-film reflecting surface(s) and inflatable structures that harden under solar ultraviolet light.

As noted previously, microwave and laser photons are not the only source of energy that is contemplated. As considered herein, sunlight is also a form of radiant energy. Sunlight may be redirected (or reflected) by a transmitter to a concentrator or it may come directly from the sun. In some applications, concentrators may be utilized that can directly track the sun, therefore enabling sunlight to be one of the potential radiant energy sources for thermochemical conversion.

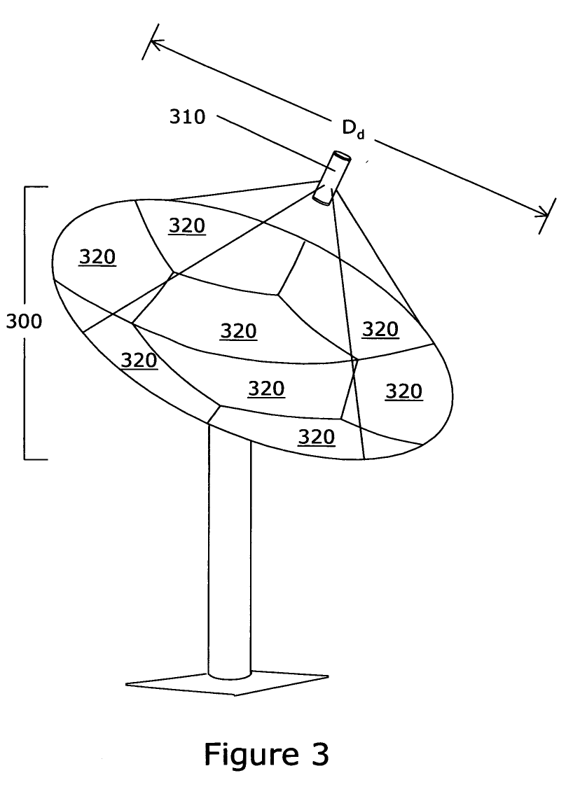

FIG. 3 illustrates a parabolic dish concentrator 300, of overall diameter D_{d}, with a thermal receiver 310 at its focal point. In principle, concentrators of this sort can intensify radiant energy by a factor of about 10,000 to 20,000. The dish consists of multiple segments 320—in this illustration there are eight segments—which can be separately manufactured and assembled on site and the receiver is mounted from the dish. Not shown in the figure is insulation that in actual applications would be wrapped around or placed on the receiver or the insulated piping that would transport fluids to and from the receiver.

### Hybrid Concentrators

Hybrid concentrators may also be appropriate for space and terrestrial applications, being capable of processing solar, visible laser and/or microwave energy. For example, for terrestrial applications, a hybrid concentrator might point at and track the sun during periods of sunlight and the same hybrid concentrator might point at and track an orbiting transmitter when the sun is not available.

Microwave energy beamed from orbit can be produced for safety reasons at power densities (flux, in kWᵣ/m²) at about one-fifth to one-third of the power density of intense solar energy. See the Union Radio-Scientifique Internationale International Union Of Radio Science URSI White Paper on Solar Power Satellite (SPS) Systems (Reference: http://www.ursi.org/WP/WP-SPS%20final.htm) and “Solar Power Satellites”, Office of Technology Assessment, 1981 (Library of Congress No. 81-600129). For hybrid systems, where microwave energy is one of the forms of radiant energy, two choices are apparent. Since the microwave energy flux is less than the solar energy flux, the process rate for the thermochemical system can be appropriately reduced. Alternately, additional surface could be provided for the concentrator, allowing the power flux at the receiving unit to be greater. It is noted that many surfaces that are good reflectors for visible light should also be good reflectors for microwaves; however, surfaces that are only for reflecting microwave energy are not necessarily good reflectors for visible light. For example, satellite dishes designed to receiver microwaves often employ a porous mesh reflector surface rather than a solid reflector surface. Preferably, if a mesh surface is employed, the pores are smaller than the wavelength of the receiving microwave energy in order to reflect the majority of the incoming energy to the focal point of the concentrator. Advantages of employing a mesh surface include reductions in the weight of the concentrator and in wind forces since air can pass through the mesh.

As previously noted, 2.45 and 5.8 GHz are two frequencies that have been considered for the powerbeam from a powersat, respectively corresponding to wavelengths of 12.2 and 5.2 centimeters. Accordingly, average pore sizes of 6.1 and 2.6 centimeters would correspond to ½ of these wavelengths and would be effective reflectors.

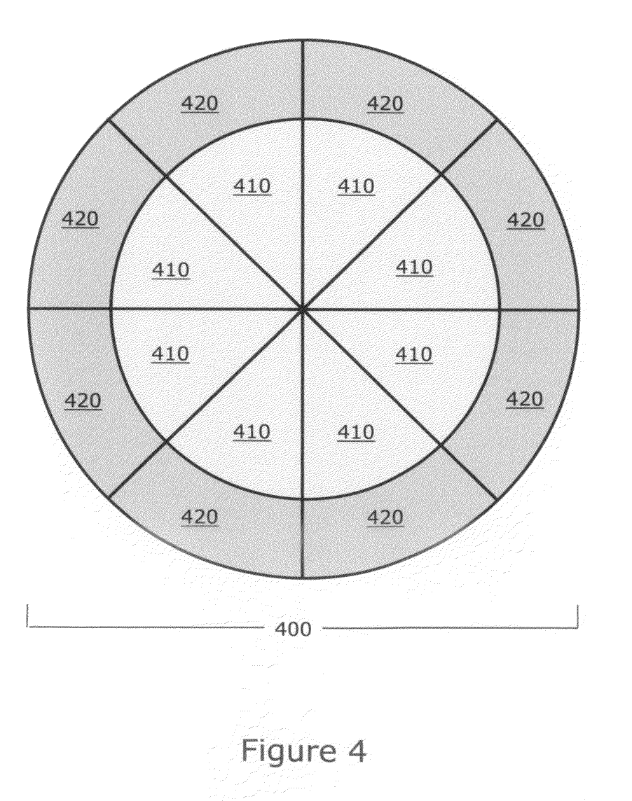

FIG. 4 illustrates the concept for a hybrid, parabolic dish concentrator 400 in a view that is similar from that of the focal point of the dish. Here, an inner section 410 contains segments that are highly reflective for sunlight, such as conventional mirrors, and an outer section contains segments 420 that are highly reflective to microwave radiation (e.g., a metal mesh). In this illustration, the proportions of the two sections have been selected so that they represent approximately equal total surface areas in the figure. Assuming that the microwave powerbeam is ¼^{th} the radiant energy density of the sun, a dish of this design, when pointed at a powersat, would deliver ½ of the radiant energy to a radiant energy receiver as when pointed at the sun. Further assuming that the system points at the sun for ¼ of an average day, and at the powersat for ¾ of an average day, and assuming that the solar energy reflected to the receiver is negligible, the average capacity factor obtained would be:

Capacity Factor=(½×1)+(¾×½)=0.625

or about 62.5% of full capacity operation. In this case, the hybrid system enables an increase in the average production rate for a thermochemical plant of about 150% compared to operating only when sunlight is available. As will be discussed later, greater capacity factors can be achieved, theoretically up to 100% in principle, if the mesh structure takes up a larger area or alternately if a supplemental energy source, such as combustion heat or electrical resistance heat) is provided in support of the thermochemical process system.

### Thermal Energy Receiver

Thermal energy receivers, or thermal receivers, are radiant energy receivers that absorb photons, converting them to heat, preferably heat that is at a moderate or high temperature. The thermal receiver can be placed at or adjacent to the focal point of a concentrator, or radiant energy may be routed into the thermal receiver through a light pipe, fiber optics, or any other optics that are capable of redirecting radiant energy from a focal point to the thermal receiver.

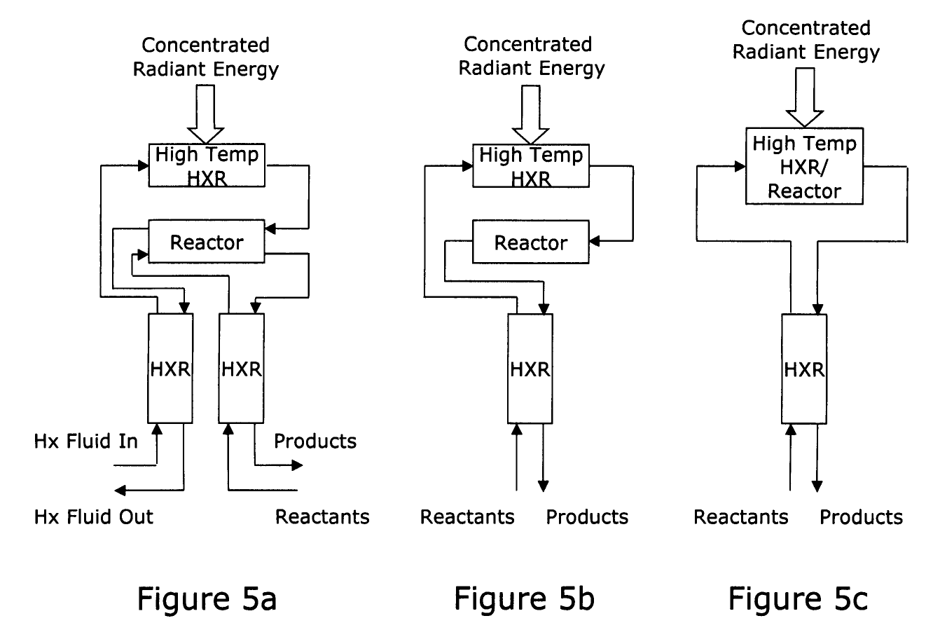

The heat that is generated in the thermal receiver is either a) used to directly heat a portion of the thermochemical processing system (specifically, in a unit that performs an endothermic chemical process), b) used to directly heat a fluid stream containing chemicals that are to be subsequently processed in the thermochemical processing systems, or c) used to heat a separate heat transfer fluid, which subsequently or in tandem provides heat to the thermochemical processing system. These three alternative configurations are depicted in FIGS. 5a, 5b and 5c, each of which also shows at least one intermediate recuperative heat exchanger. All of the components in FIGS. 5a, 5b and 5c are preferably a part of the thermal receiver located at or in close proximity to the focal point of a concentrator.

In FIG. 5a, a heat transfer fluid selected for the application is preheated in a recuperative heat exchanger (“HXR”), then further heated in a high temperature heat exchanger before being passed through an integrated reactor/heat exchanger where it provides heat to a separate, reacting fluid, supporting an endothermic chemical reaction. From the reactor, the heat transfer fluid is then cooled while again passing through the recuperative heat exchanger. Note that the reacting fluid is separately preheated in a second recuperative heat exchanger prior to being routed to the reactor where it receives heat from the heat transfer fluid as the reaction proceeds. The reacting fluid then is cooled in the second recuperative heat exchanger. At no point in the system are the two fluids mixed.

An advantage of the configuration of FIG. 5a is the substantial amount of recuperative heat exchange. This reduces the amount of energy that is required for the net chemical process; it also simplifies fluid control since it allows relatively cool fluids to be transported to and from the thermal receiver and its associated components.

FIG. 5b is an improvement over the configuration of FIG. 5a as it eliminates the need for the heat transfer fluid and therefore reduces some of the potential thermodynamic irreversibilities associated with heat transfer. In the configuration of FIG. 5b, reactants are preheated in a recuperative heat exchanger, and then passed through a high temperature heat exchanger reactants are directly heated. After departing the high temperature heat exchanger, the reactants are passed through a chemical reactor, where the reaction occurs, and then through the recuperative heat exchanger, cooling the products of the reaction. As in the configuration of FIG. 6a, this system is advantageous over many other possible systems in that it allows relatively cool fluids to be transferred to and removed from the thermal receiver and its associated components.

The configuration of FIG. 5c provides an additional improvement over the configuration of FIG. 5b in that there is no separate high temperature heat exchanger. Integrating the chemical reactor and the high temperature heat exchanger facilitates heat transfer since the endothermic reaction process otherwise tends to cool the fluid and therefore provides greater heat flow from the thermal receiver cavity wall into the reaction channels. It also facilitates greater overall chemical conversion, since equilibrium conversion is directly proportional to temperature for endothermic chemical reactions. This is particularly advantageous since material properties may likely limit the temperature at which thermal receivers can be operated (and therefore would also limit heat transfer rates and chemical conversion). Accordingly, the configuration of FIG. 5c is preferred over the configurations of FIGS. 5a and 5b.

The configuration of FIG. 5d presents yet another improvement. In this configuration, at least one component of the reacting fluid is initially vaporized using heat from a less expensive concentrator, such as a parabolic trough concentrator, that cannot reach the same degree of radiant energy intensity as can be obtained by a parabolic dish concentrator. Here, moderate- to high-temperature heat is needed for an endothermic chemical reaction and low- to moderate-temperature heat is needed to vaporize one or more reactants. An example where this configuration may be useful is for the steam reforming of a hydrocarbon such as methane. For this, it is desirable to heat liquid water to make steam prior to mixing it with the other reactant, methane.

In all cases, it is preferred that the recuperative heat exchangers be designed to perform with high exergetic efficiency. Where compact sizes are desired, it is also preferred that the recuperative heat exchangers be microchannel recuperative heat exchangers such as will be discussed in the following section.

### Thermochemical Processing System

The thermochemical processing system is a network of subsystems and components that collectively perform chemical reactions, heat exchange and/or chemical separations to transform materials that originated as space or terrestrial resources, into useful propellants, fuels or other chemical products.

At least a portion of the thermochemical processing system needs to be located at or in close proximity to the focal point of the concentrator in order to minimize thermal losses. Accordingly, this places volumetric limitations on some of the subsystems and components that make up the thermochemical processing system.

More specifically, at least one moderate- to high-temperature, endothermic chemical reactor is a preferred feature of the thermochemical approach to producing solar fuels and chemicals. FIG. 6 presents a generic chemical process flowsheet including additional steps for purification of the product and for recycle, plus heat exchangers that recuperate thermal energy and/or help to control the chemical reactions and separations steps. Specific chemical process flowsheets will vary from case to case, depending upon feedstocks, chemical products, methods of chemical separations, and the overall need to thermally integrate and otherwise optimize the process into an energy-efficient, financially-competitive operation.

At least one low- to moderate-temperature, exothermic chemical reactor is also shown in FIG. 6 and is desirable for many of the potential solar chemicals that might be produced using solar or other radiant energy. For example, for the production of hydrogen using methane as a feedstock chemical, the endothermic, steam reforming of reaction can be followed by an exothermic, water-gas-shift reaction. The latter reaction increases the hydrogen content of the product stream while producing heat that can be used elsewhere in the overall chemical process. Alternately, if long-chain hydrocarbons are the desired product, the endothermic steam reformer may be followed by an exothermic Fischer-Tropsch reactor.

Preferably, the recuperative heat exchanger and the high temperature endothermic reactor, which is also a high temperature heat exchanger, are directly embedded within the thermal receiver.

The separations and purifications operations, also identified in FIG. 6, may additionally produce heat that can be used elsewhere in the chemical process or which must be rejected to the environment. For example, thermal-swing sorption processes and distillation processes each require heat from a moderate temperature source and reject heat at a lower temperature. Alternate separations processes include membrane separations and pressure swing separations, either of which may additionally be incorporated in the thermochemical process.

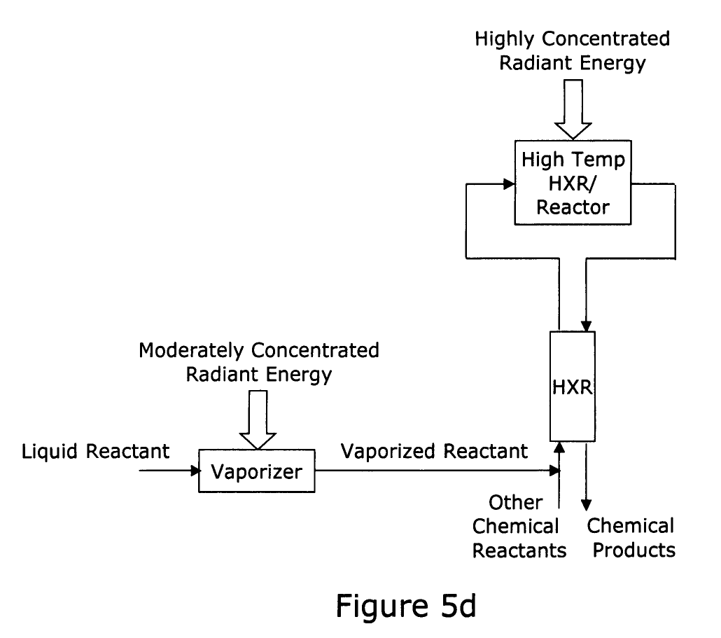

The table in FIG. 7 lists the idealized net chemical reactions for some of the feedstocks and solar chemical products discussed herein, omitting many of the details that are already known to those skilled in the art. For example, while the idealized net reaction for producing Fischer-Tropsch hydrocarbons from methane does not show the consumption of water, those familiar with these processes are aware that some makeup water will be required since it is extremely difficult to completely separate and recycle all water from the product stream.

Considering hardware volumetric and mass requirements, the best thermochemical processing system is likely to be one that has a high rate of productivity (measured in terms such as heat transfer power density and kilograms per minute of chemical product per unit volume or mass). With this in mind, the system is preferably one that employs process-intensive, microchannel processing components.

Specific microchannel reactors, separators and heat exchangers have recently been shown to exhibit extremely rapid heat and mass transport, due to having one dimension that is typically smaller than 1-2 millimeters, often smaller than 300 microns, and therefore exhibit thermal characteristics that are different than conventional hardware. See U.S. Pat. No. 6,200,536, Tonkovich, A., et. al., “Active microchannel heat exchanger”, 2001; and U.S. Pat. No. 6,540,975, Tonkovich, A., et. al., “Method and apparatus for obtaining enhanced production rate of thermal chemical reactions”, 2003; U.S. Pat. No. 6,630,012, “Wegeng, R., et. al.,” Method for thermal swing adsorption and thermally-enhanced pressure swing adsorption”, 2003; U.S. Pat. No. 7,125,540, Wegeng, R. et. al., “Microsystem process networks”, 1973; and U.S. Pat. No. 7,297,324.

Microchannel process technology provides several advantages for thermochemical processing systems, including:
Efficient heat transfer, reactions and separations. Due to their small cross-sectional dimensions, microchannel heat exchangers, chemical reactors and separators operate with high heat transport rates despite relatively low temperature differences.
Process intensive operations. Microchannel heat exchangers and reactors typically obtain internal heat fluxes of 10-100 watts/cm² and heat transfer power densities of 10-50 watts/cm³ or higher. For a system that processes about 100 kWᵣ power from a solar concentrator, this translates to a hardware volume of about 2 to 10 Liters (0.002 to 0.01 m³) for the high temperature microchannel reactor. The overall hardware volume for a complete microchannel process network, comprising those unit operations that would be placed at the focal point of a 100 kWᵣ parabolic dish concentrator unit, is preferably be smaller than about 0.1 to 1.0 m³.
Modular designs support modular construction/installation and maintenance approaches. The compact size and modular nature of microchannel process technology readily adapts itself to the installation of modules at the focal points of concentrators. Reliability can be enhanced through the use of separately addressable modules, which can be turned off or shut down in response to variations in energy input, product demand, or failures within individual units.

The relatively small size also facilitates selected forms of maintenance, such as changing out individual units or systems. With conventional hardware, unit sizes, which may be one-to-two orders of magnitude larger than their corresponding microchannel units, may be too large to readily enable changing out of individual reactors, heat exchangers, or entire systems, etc.

Thermal Energy Receiver with Embedded Channels

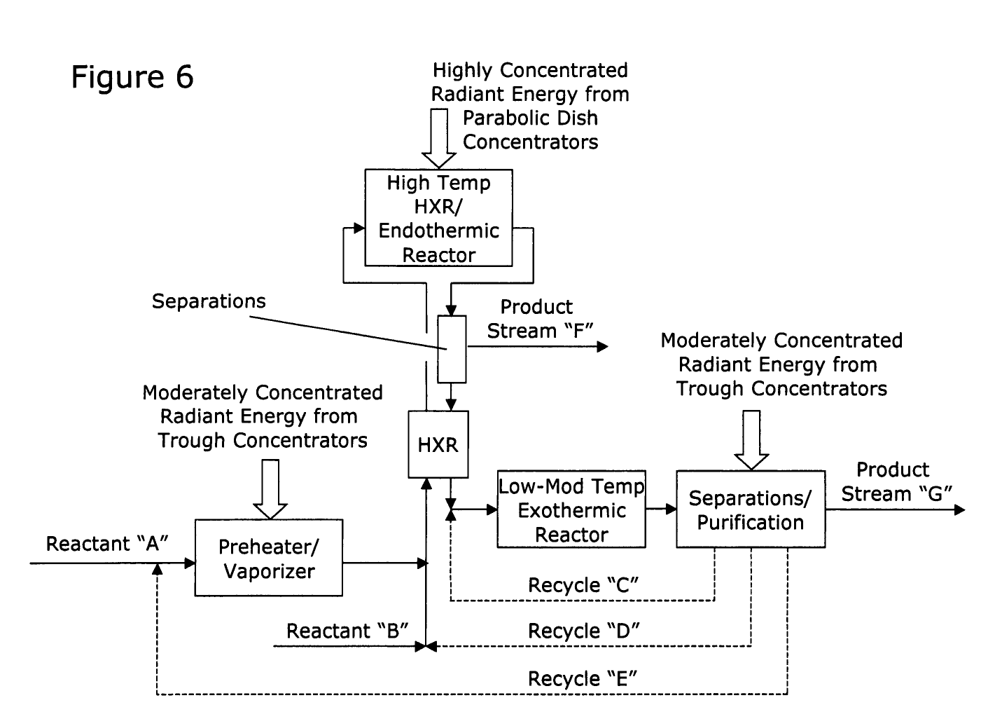

FIGS. 8a, 8b, 9, 10a, 10b, 11, 12a, 12b, 13a, 13b, 14a, 14b, 15a, 15b, 15c, 16, and 17 depict various components and aspects of thermal receivers that include embedded channels, including reaction channels, for single- or multi-component fluids. FIGS. 8a and 8b illustrate, respectively, top views and side views of individual components that make up one embodiment of the system. In FIGS. 8a and 8b the innermost portion of the thermal receiver is in the form of a first cylinder 800 that is designed so that sunlight or other radiant energy, in concentrated form, can enter a cavity opening at one or both ends. The inner diameter (D₁) of cylinder 800 is equal to or greater than the diameter of the cavity opening. If radiant energy is directed into only one end, the other end is preferentially capped or otherwise covered so that radiant energy cannot escape through that end.

In this concept, individual cylinders are nested within each other—much like Russian nesting dolls (also called Matryoshka nesting dolls)—with the innermost cylinder providing the structure for a receiver cavity within which radiant energy is directed as well as the primary surface for absorption heating. Individual cylinders provide for fluid flow, heat exchange, chemical reaction and supplemental heating, as described below.

In FIGS. 8a and 8b, the outer surface of innermost cylinder 800 provides zones for heat exchange and endothermic chemical reactions; cylinder 810 provides inner surface elements that perform manifolding of fluids for cylinder 800 and outer surface elements that provide zones for the combustion of a fuel as a supplemental source of heat; and outermost cylinder 820 provides inner surface elements that perform manifolding of fluids for cylinder 810 and an interior that provides electrical resistance heating as yet another supplemental source of heat.

In practice, the first cylinder 800 is nested within the second cylinder 810, having an inner diameter (D₃) that is preferably approximately the same as the outer diameter (D₂) of the first cylinder. In addition, the second cylinder is nested within the third cylinder 820, itself having an inner diameter (D₅) that is preferably approximately the same as the outer diameter (D₄) of the second cylinder.

The cross-sections of each cylinder are preferably of the same approximate shape, and are more preferably a circle. However, those skilled in the art will be aware that other cross-sections such as ellipses and other curved shapes are allowable, as are non-curved cross-sections such as triangles, squares, other rectangles, and other multi-sided units. Those skilled in the art will also be aware that the same system can be formed in a monolithic structure, or other structures, and need not necessarily be formed as cylinders that are fit together.

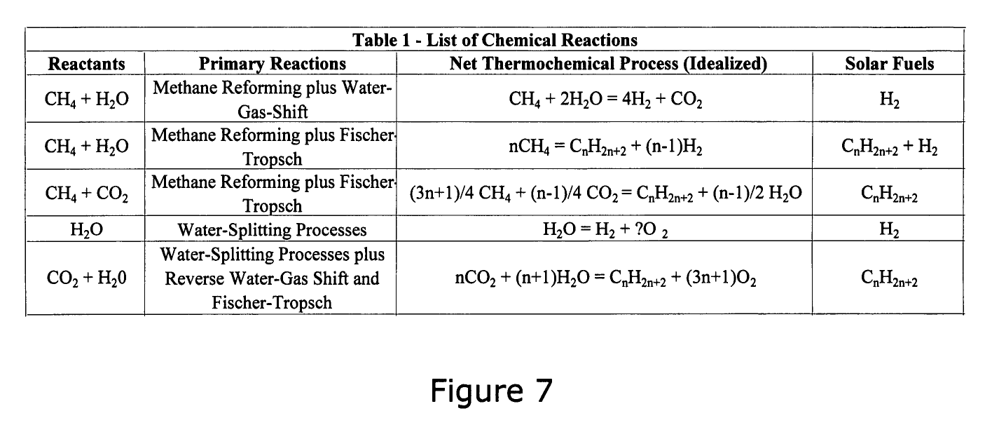

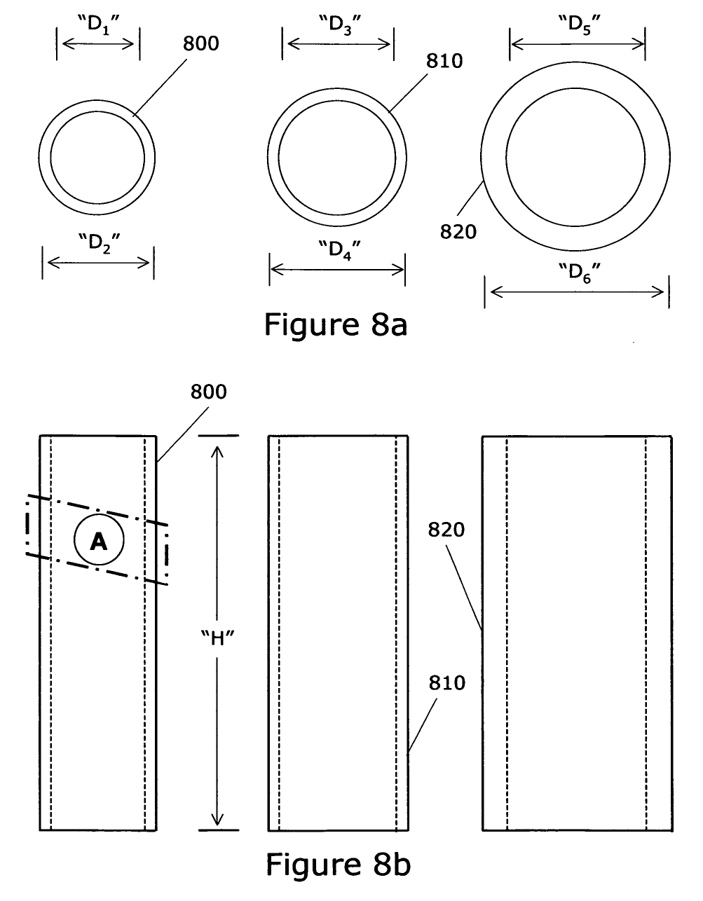

FIG. 8b additionally shows the location of a sectional A in the first cylinder, the area within which is magnified in FIG. 9, representing one embodiment that demonstrates the use of microchannels 900, which are also depicted in FIG. 10 running perpendicular to the length of the first cylinder 800. For this case, the microchannels, which are of depth “d”, are concentric reaction channels that have been formed so that they run around the outer perimeter of the first cylinder. However, the microchannels could alternately be formed on the surface of the first cylinder at any angle, and they do not necessarily have to individually form continuous channels. For example, one or more microchannels could be formed in a spiral.

In general, microchannels can be machined or otherwise formed through a variety of methods; for microchannels with very high aspect ratios (ratio of depth to width, mechanical or electromechanical devices such as slitting saws and electrodischarge machines can be used.

As shown in the top views of FIGS. 10a and 10b, manifolding channels 1000 have also been formed within the inner surfaces of the second and third cylinders, 810 and 820, and run at least a portion of the length of the cylinders whereas the microchannels in FIG. 9 preferentially run in a direction that is generally though not necessarily orthogonal to these. As the figure suggests, the manifolding channels on the inner surfaces of the second and third cylinders are larger in cross-section and fewer in number than the microchannels on the outer surface of the first cylinder. The manifolding channels depicted in FIGS. 10a and 10b act as headers and footers; as headers, they bring fluids into the microchannels, and as footers they are fluid passages that allow the fluids to exit the microchannels. Note that an individual manifolding channel can serve as both header and footer, such as in a case where a manifolding channel receives fluid from one set of microchannels and directly transports it to yet another set of microchannels.

If heterogeneous catalytic reactions are desired, catalysts may be placed within or formed within the reaction channels. The catalysts may be placed against or formed against or otherwise applied to reaction channel walls, such as through a wet-coating process, or they may be placed against the reaction channel walls or elsewhere within the reaction channels as inserts. See U.S. Pat. No. 6,488,838, Tonkovich, A., et. al., “Chemical reactor and method for gas phase catalytic reactions”, 2002; and U.S. Pat. No. 6,540,975, Tonkovich, A., et. al., “Method and apparatus for obtaining enhanced production rate of thermal chemical reactions”, 2003.

FIG. 10b additionally shows slots 1010 for the placement of electrical resistance heaters, which can aid startup of the system as well as serve as a source of supplemental heat during operation. Note however that electrical resistance heaters can be added to the receiver via any number of ways, such as by wrapping the outside of the outermost cylinder with a flexible electrical resistance heater prior to covering the receiver system with an insulating material. Alternately, to reduce machining costs, electrical resistance heaters can be added to the outside of cylinder 820.

In operation, solar or other radiant energy is preferably intensified by a concentrator and directed into the thermal receiver cavity, where photons contacting the cylinder walls are absorbed or reflected. Preferably, the majority of the reflected radiant energy is subsequently absorbed elsewhere by other locations on the inner cylinder walls. The cavity depth is preferably large compared to the cavity width, preferably by a factor of at least 2 to 1, and more preferably by a factor of at least 3 to 1, thereby enabling the cavity to act much like a blackbody cavity, absorbing the majority of the incoming radiant energy. Absorbed radiant energy is then conducted as heat through the cavity walls into the reaction channels and into the fluid thereby providing the heat of reaction for the endothermic chemical reaction. In addition, to minimize the escape of emitted infrared thermal radiation through the cavity opening, a cover window may be added that is generally transparent to the incoming radiant energy while being non-transparent to infrared radiation.

Preferably, the absorption of radiant energy by the inner surface of the cavity, which is also the inner surface of the first cylinder, maintains the inner cavity wall at a temperature that is high enough to sustain the desired reaction. For example, if methane reforming is to be carried out in the thermal receiver's reaction channels, the temperature is preferably above 500 C, more preferably above 600 C, and still more preferably above 700 C. Accordingly, the cavity materials selection must take into account the desired operating temperature for the reaction of interest. For example, stainless steel is acceptable for temperatures less than 600 C to 700 C, whereas inconel or other high temperature alloys may be preferred at higher temperatures. For very high temperatures, where high temperature alloys are not acceptable, other high temperature materials such as ceramics may be used.

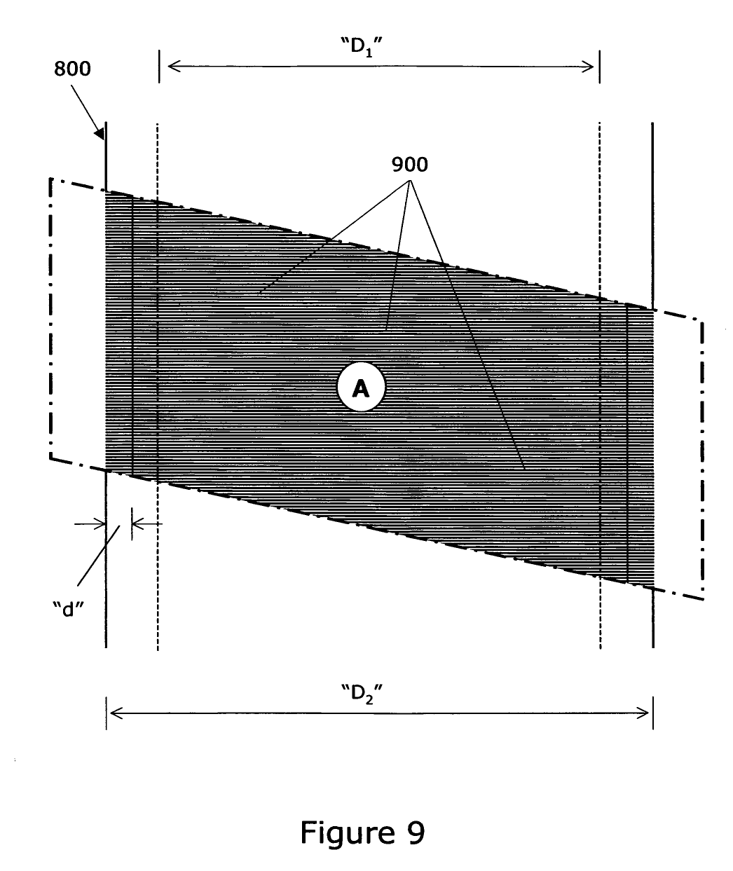

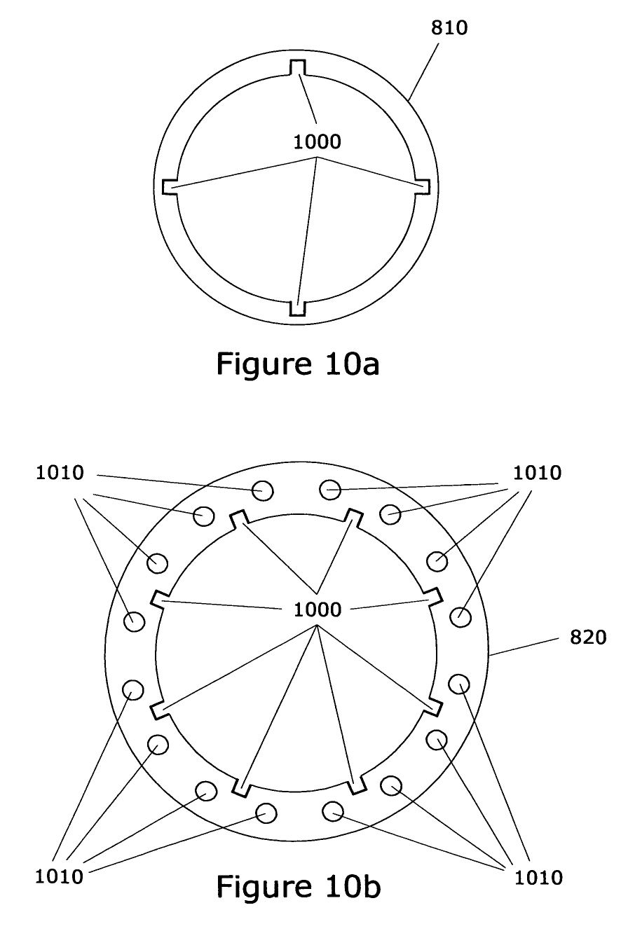

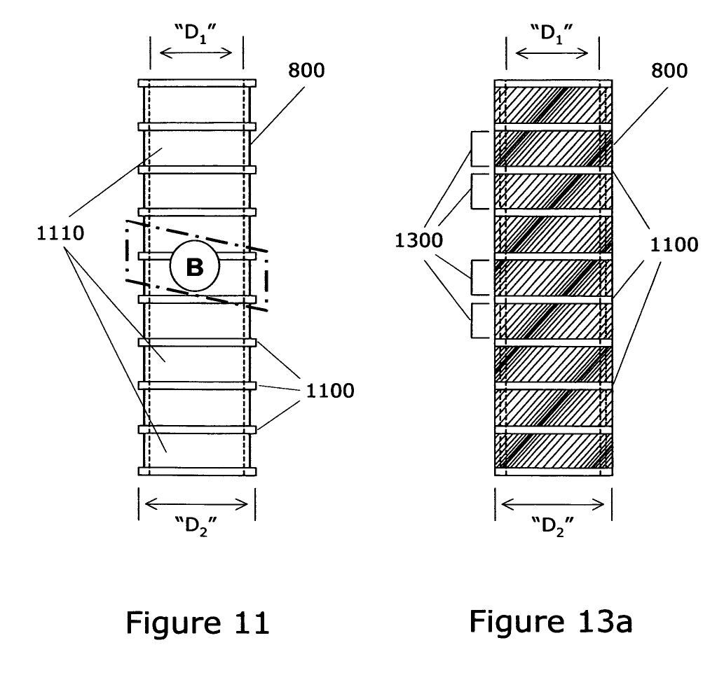

FIG. 11 illustrates an alternative design for the inner cylinder 800 where raised surfaces 1100 separate individual areas consisting of microchannels. The area that is highlighted by the sectional in FIG. 11 is magnified in FIG. 12a, thereby depicting both the microchannels and the raised surfaces. The raised surfaces allow additional flexibility in configuring fluid flow within the system; for example, reacting fluids can be directed through one set of microchannels and then through a second set of microchannels. In particular, this embodiment provides the ability to exploit nonuniformity in radiant energy absorption—and therefore heat flux—within various locations in the thermal receiver. For example, since the degree of conversion of an endothermic reaction is directly proportional to the temperature of the reaction, the ideal reactor system will begin the reaction at a relatively low temperature and complete it at a higher temperature. According, the use of raised surfaces allows the separation of reaction zones 1110 within the thermal receiver; by properly positioning headers and footers, the second cylinder provides manifolding that allows an initial degree of reaction in a lower temperature reaction zone and greater reaction at a higher temperature reaction zone.

In general, heat is conducted into reaction zones through the walls—which act like heat transfer fins—of the microchannels. The microchannels are preferably high aspect ratio channels, having substantially greater depths than widths. Preferably the microchannels have widths that are less than one or two millimeters and depths that are one centimeter or greater. Since extremely thin walls, between microchannels, would not perform effectively as heat transfer fins, the walls are preferably at least as wide as the microchannels.

FIG. 12b illustrates a magnified view of an exploded cross-section of cylinders 800, 810 and 820. The inner side of cylinder 800 is shown on the extreme right side of the figure, with microchannels 900 and raised surfaces 1100 on the cylinder's outer side. In the center, cylinder 810 is shown, with a partial view of a manifold 1000 supporting the reaction process, that takes place in the microchannels 900, on the inner (right) side of the cylinder, and raised surfaces 1100 plus a larger channel 1200 for combustion on the outer (left) side of the cylinder are also depicted. A porous insert 1200 for a combustion catalyst is also shown (with diagonal crosshatching), which sits inside channel 1200. In addition, the outermost cylinder 820 is shown on the left side of the figure, with a manifold 1000 supporting the combustion process. Finally, slots 1010 for the placement of an electrical resistance heater are shown within cylinder 820.

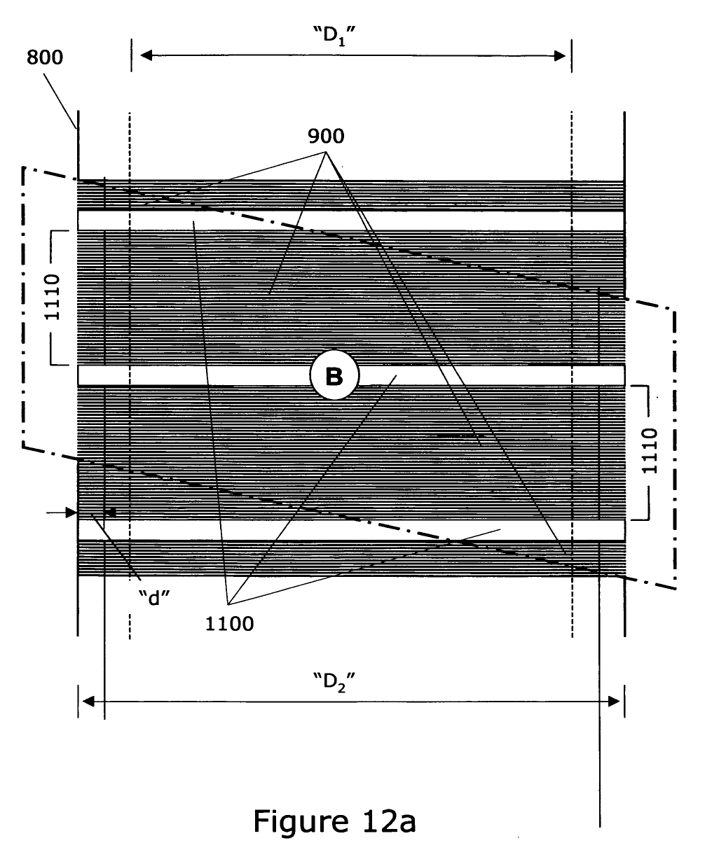

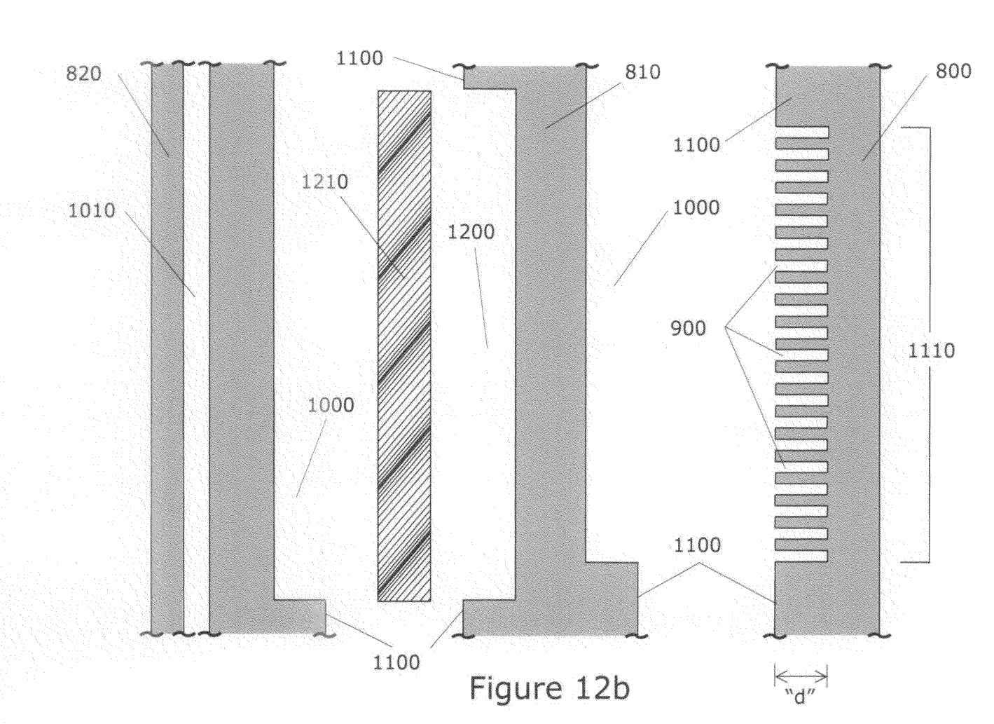

FIG. 13a depicts an alternative design for the first cylinder 800 that does not make use of microchannels. Instead, for this embodiment, the open space between raised surfaces constitutes large channels, preferably centimeters or greater in width, in which thermally-conductive porous structures 1300, such as metal foams, are placed that are selected for their ability to support heat transport and fluid flow. Preferably, the thermally-conductive porous structures 1300, which are further indicated in FIG. 13a by diagonal crosshatching, include connected pores that are at least a few hundred microns in size so that fluids do not experience excessive pressure drops. For this alternative to the use of microchannels, heat is conducted from the inner wall of the first cylinder through the porous structure, therefore heating the fluid and supporting endothermic reactions if desired. For heterogeneous catalytic reactions, the catalyst is deposited on or otherwise emplaced within the pores.

FIG. 13b illustrates a magnified view of an exploded cross-section of cylinder 800 for the alternative embodiment of FIG. 13a. In this case, we also illustrate an alternative to the system concept that incorporates only electrical resistance heating as the supplemental energy source; hence, only inner cylinder 800 and outermost cylinder 820 are depicted, and there are no channels, manifolds or catalyst inserts supporting combustion. More specifically, cylinder 800 is shown on the right side of the figure, which further incorporates a reaction zone 1110 in which the thermally-conductive porous structure 1300, containing a catalyst that has been selected for the endothermic reaction of interest, has been placed. Cylinder 820 on the left side of the figure includes manifold 1000, which acts as a header or footer for the reaction zone, and slot 1010 for the placement of an electrical resistance heater.

As mentioned previously, it is possible to configure the thermal receiver unit so that it receives energy from a second energy source, such as from an exothermic reaction (e.g., the combustion of a fuel) or from electrical resistors. Preferably, combustion heat is generated in combustion zones that are built into the outer surface of cylinder 810 of FIGS. 8a, 8b, 10a and 12b. Fuel and oxidizer are fed, and combustion products are removed, through the manifolding channels 1000 indicated in FIG. 12b and which are formed within the inner surface of cylinder 820. The fuel may be any ordinary fuel, or may be recycled reaction products from the overall thermochemical processing system. For example, methane, ethane and very long-chain hydrocarbons (e.g., waxes) are among the less desirable products of a Fischer-Tropsch reactor, which must be removed from the final product stream and preferably are either recycled as feedstock to the endothermic reactor or combusted so that their chemical energy content can be recycled.

Most preferably, catalytic combustion is performed in combustion zones that are of the same concept as the alternative reaction zones of FIG. 13a, within porous inserts located between raised surfaces. In this case, because combustion is an exothermic reaction that is generally self-sustaining, the thermal conductivity of the porous inserts is not as critical to the operation of the system; therefore monolithic ceramic catalyst inserts are acceptable.

More specifically, a gaseous fuel and an oxidizer are directed into the manifolding channels of the third cylinder 820, which directs them to the combustion zones of the second cylinder 810, where catalytic combustion occurs and heat is generated. The heat of combustion is absorbed by the walls of cylinder 810 and conducted radially to the reaction channels of cylinder 800, in support of the endothermic reaction. In this way, combustion heat can be used to operate of the system when radiant energy is not available or when it is insufficient to drive the system at a high throughput rate.

Integrating endothermic reaction channels with radiant heat absorption and/or combustion channels is an efficient way to configure chemical reaction systems. It is volume-efficient in that it allows both endothermic and exothermic unit operations to be obtained in a small, compact system. It is energy-efficient because heat transfer occurs with minimal temperature differences, thereby reducing energy destruction in the unit. It is also reaction-efficient in that it provides an internal, passive feedback mechanism whereby hot spots that might have a tendency to form in the receiver cavity or the combustion zones result in greater conversions (and therefore greater heat demand) in adjacent endothermic reaction zones, since endothermic reactions obtain higher conversions and kinetics when they are operated at hotter temperatures. In this way, the system provides a form of passive temperature control that limits the creation and growth of hot spots that could cause potential damage to the hardware of the system.

### Thermal Receiver Absorption Enhancements

As previously mentioned, the cavity of a thermal receiver is preferably designed with a high aspect ratio, so that reflected photons—on the average—continue to strike the cavity walls multiple times, and therefore have multiple opportunities for absorption, prior to passing back through the cavity opening. We note in particular that metals are highly reflective to microwaves, and some photons enter the cavity with a low incidence angle; therefore some photons have little opportunity for absorption within an unimproved cavity. Accordingly, an improvement is the inclusion of absorption enhancements, which increase absorption rates and/or the number of internal reflections.

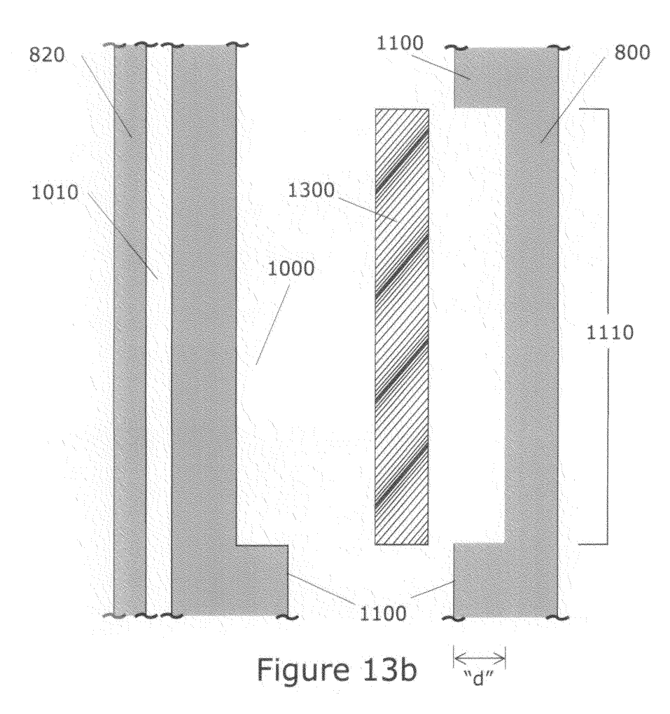

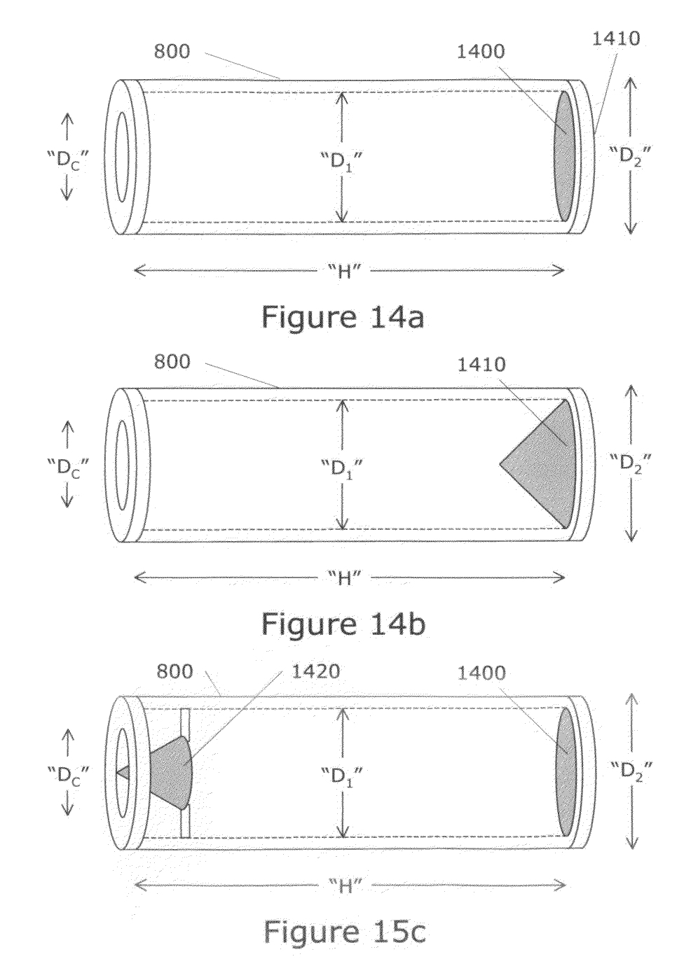

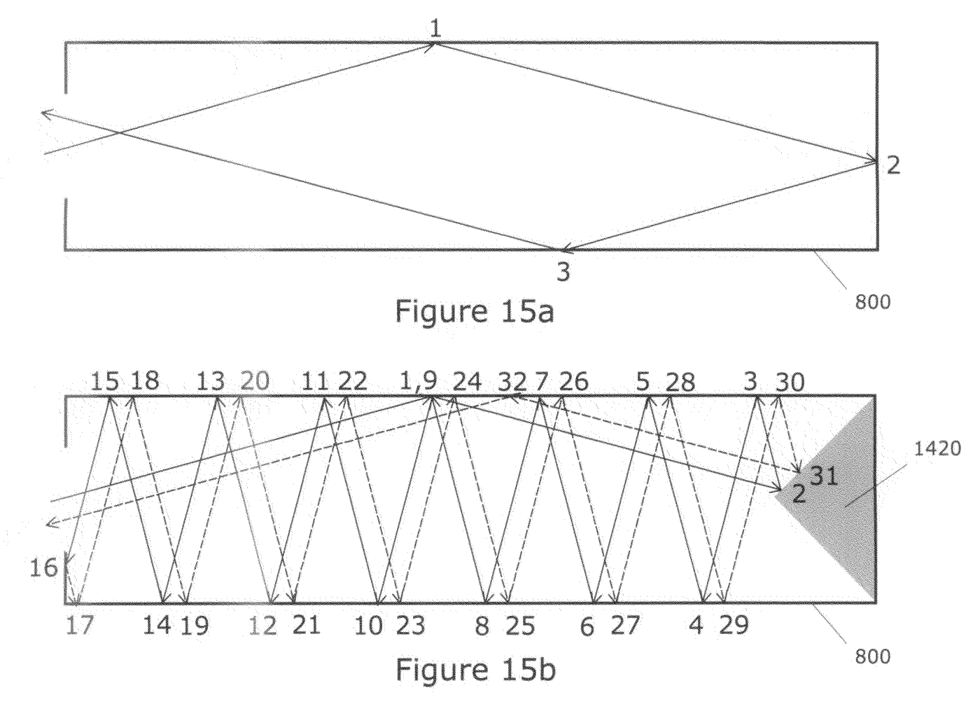

Absorption enhancements, illustrated in FIGS. 14a, 14b and 15c, include the use of susceptor materials, which increase the absorption of photons, and the use of reflecting disks, which modify the angle of incidence for photons. For example, silicon carbide couples well with and absorbs microwaves more readily than metals.

Susceptor materials may be incorporated within a thermal receiver cavity as either coatings on cavity walls or as emplaced units. For example, FIG. 14a illustrates the placement of a silicon carbide disk 1400 against the cavity endpiece 1410 of cylinder 800. This enhancement results in a higher absorption of microwaves, driving the silicon carbide disk to a high temperature. A portion of this heat is then directly conducted into the cavity endpiece 1410, which may have embedded reactor and/or heat exchanger channels; in addition, heat is radiated from the disk primarily into the cylinder walls with only a small percentage making its way out of the cavity through the cavity opening.

A reflecting structure is another type of absorption enhancement. FIG. 14b illustrates a reflecting structure placed at the end of the cavity. This absorption enhancement generally changes the angles of incidence and reflection for photons that are reflected off the cone walls.

To understand the value of the improvement of a reflecting structure, consider a 45 degree cone reflector 1420, as depicted in FIGS. 15a and 15b. For photons entering the cavity with a low angle of incidence to the cavity walls, striking the cone reflector generally changes the angle of incidence to the “complement” of the previous angle of incidence. That is, the new angle of incidence is 90 degrees minus the previous angle of incidence.

Thermal energy receivers that are mounted at the focal point of parabolic concentrators, such as were illustrated in FIG. 3, will receive photons that have initial angles of incidence that vary between a few degrees and about 40-50 degrees; in preferred designs, all of the incoming photons will be less than 45 degrees. Accordingly, unscattered photons that have had an odd number of reflections off the cone reflector will be transformed into photons with angles of incidence that are greater than 45 degrees, ensuring many subsequent opportunities for absorption. Of course, unscattered photons that have had an even number of reflections will be returned to their original angle of incidence, but this is no worse than if the cone were not included. FIGS. 15a and 15b illustrate the advantage for an incoming photon with an initial 15 degree angle of incidence. In FIG. 15a, an unscattered photon that is not readily absorbed by the channel walls is shown to reflect three times prior to exiting a cavity that has no absorption enhancement. In FIG. 15b, the inclusion of a cone reflector transforms the angle of incidence to 75 degrees; leading to a theoretical 30 reflections prior to cavity exit. Assuming an absorption rate of 10% per reflection, the cumulative absorption percentage for unscattered photons in these two cases are 27.1% and 96.6%.

FIG. 15c shows another case, where both susceptor disk 1420 and reflecting cone 1420 are incorporated within the thermal receiver. In this case, the backside of the cone reflects photons away from the cavity opening and the front side, which is not necessarily at 45 degrees, transforms the incidence angles for a majority of the incoming photons.

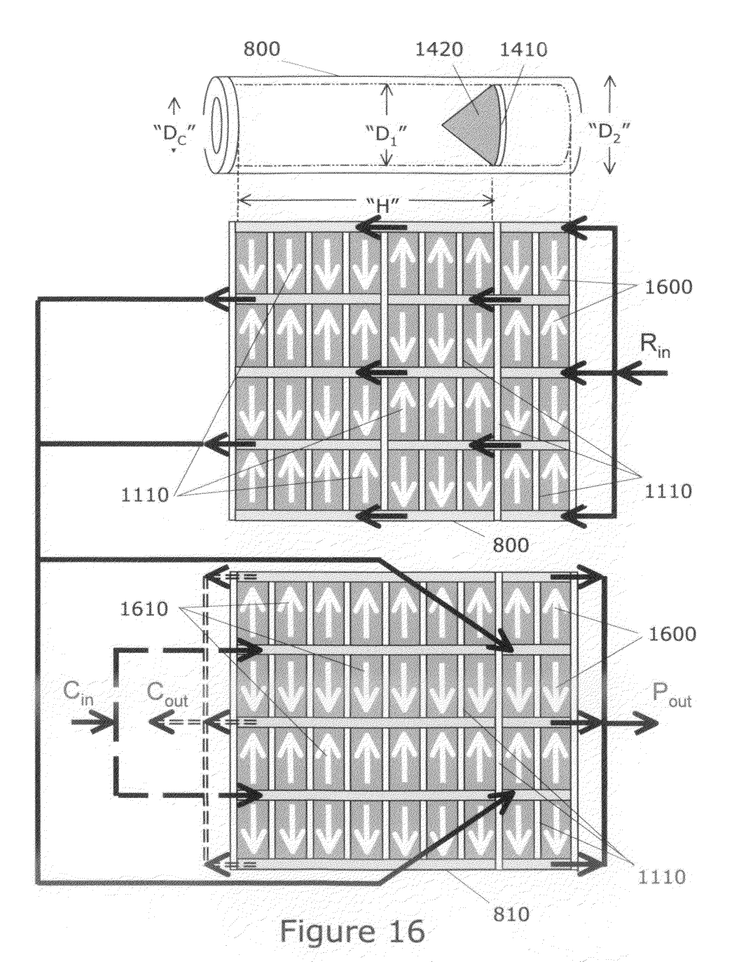

FIG. 16 depicts one possible integrated design for manifolds, reaction zones and combustion zones within an overall thermal receiver. In the figure, cylinders 800 and 810 have been “unrolled” and exploded in a graphical form that highlights fluid flow within the system. More specifically, the figure provides a graphical alignment of the unrolled cylinders in the context of cylinder 800 (at the top of the figure). The outer portion of unrolled cylinder 800 is illustrated in the central image of the figure and the unrolled cylinder 810 is illustrated in the lower image. The flow of reactants (Rᵢₙ), products (Pₒᵤₜ) and combustion fluids (Cᵢₙ and Cₒᵤₜ) through the manifolds is depicted with dark arrows, both into the manifolds, through the manifolds, and out of the manifolds, and fluid flow through the reaction zones are depicted with light arrows.

Note that some liberties have been taken in the graphical representation. For example, manifolds that are formed within the inner side of cylinder 810 are illustrated with the unrolled image of cylinder 800 in order to highlight fluid flow. Likewise, for each unrolled cylinder, one manifold is shown twice and is indicated at the top and bottom of each representation.

The thermal receiver of FIG. 16 also represents an alternative concept where the reflecting cone 1420 and cavity endpiece 1410 are placed further into the cavity than if they were at the extreme end of the cavity. This allows the portion to the right of the cavity endpiece in the figure to house heat exchanger zones while not also absorbing radiant heat.

The flow of the reacting fluid in FIG. 16 is similar to the process diagram of FIG. 5c and is as follows:
The reacting fluid (Rᵢₙ, dark solid arrows) is passed into the thermal receiver, then into a set of manifolds 1000 and a first set of recuperative heat exchanger zones 1600, where it is preheated.
The reacting fluid then passes into a second set of manifolds and a first set of reaction zones 1110, then into a third set of manifolds and a second set of reaction zones. The reaction zones contain a thermally-conductive porous material that incorporates a suitable catalysts, in support of the endothermic chemical reaction. The source of heat for this section may be radiant energy that has been absorbed by the inner wall of the cylinder 800 or it may be combustion heat, or both.
The products of reaction (Pₒᵤₜ) then collect in a fourth set of manifolds, exiting cylinder 800 and are passed through into a fifth set of manifolds in the heat exchanger zone of cylinder 810 and are then cooled while routing through a second set of recuperative heat exchanger zones 1600. The products of reaction are then collected within a sixth set of manifolds for routing out of the thermal receiver.

The flow of the combustion fluids in FIG. 16 is represented in double-dashed lines and is as follows:
Combustion gases (e.g., fuel and oxidizer; Cᵢₙ) are passed into the thermal receiver system, into a first manifold 1000 and a set of combustion zones 1610, where the exothermic combustion process occurs.
The products of combustion (Cₒᵤₜ) are then collected in another set of manifolds and are passed out of the thermal receiver.

Those skilled in the art will appreciate that the previous description conveys but one routing scheme for fluids within the thermal receiver. This routing has assumed that the design of the receiver cavity, including absorption enhancements, provided greater temperatures in the region that is closest to the location of the cone reflector 1420 as shown in FIG. 16. Since there are many possible ways to configure absorption enhancements within the cavity, there are also many possible optimizations for fluid flow in the cylinders.

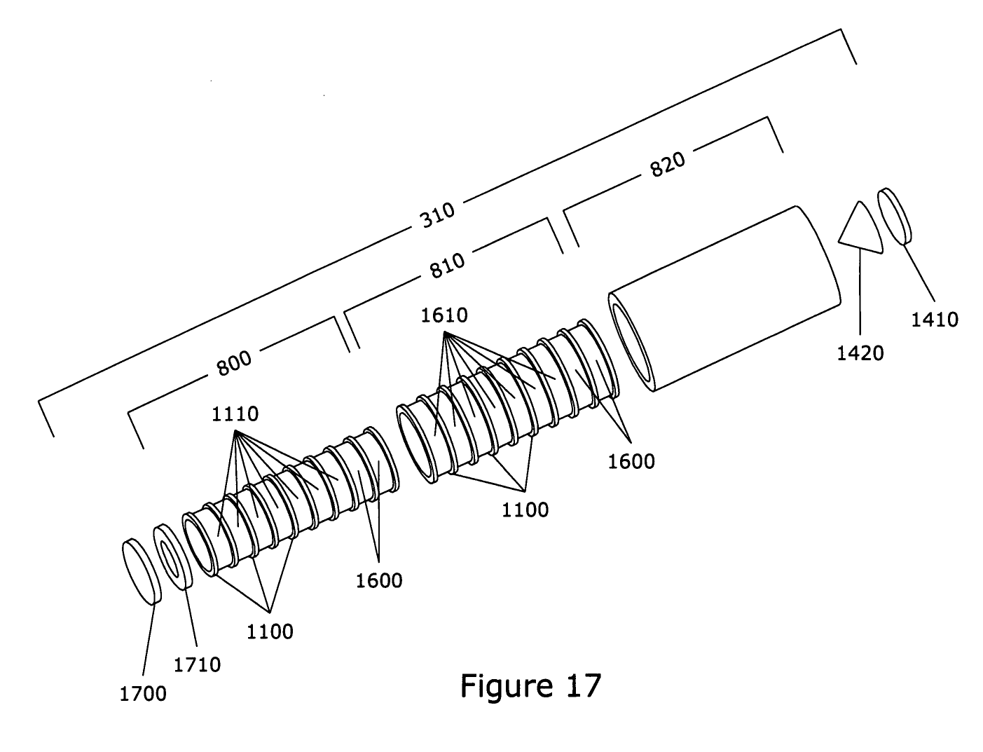

FIG. 17 provides an exploded illustration of a thermal receiver 310 with nested cylinders for thermochemical processing, based on the integrated design of FIG. 16 and incorporating a thermally-conductive porous structure for the catalytic endothermic reaction. In the figure we show a quartz window 1700, which is transparent to both visible light and microwaves; an aperture piece 1710, which provides the opening to the cavity; innermost cylinder 800 with raised surfaces 1100, reaction zones 1110 and heat exchange zones 1600; cylinder 810 with raised surfaces 1100, combustion zones 1610 and heat exchange zones 1600; outermost cylinder 820; cone reflector 1420 and cavity endpiece 1410. Not shown are manifolds within the inner surfaces of cylinders 810 and 820; porous catalysts for the endothermic reaction and combustion; microchannel for recuperative heat exchangers; electrical resistance heaters which are fitted within slots of, or positioned on the surface of, cylinder 820; instrumentation and controls; external piping connections that bring fluids to and from the thermal receiver; and insulation.

### Example Thermal Receiver Calculations

In principle, we can examine a case where the thermal receiver cavity opening has a diameter D_{c}, the first cylinder has an inner diameter D₁, the depth of the cavity is H, and the cavity receives radiant energy from a parabolic concentrator of net diameter D_{d}. The concentrator intercepts radiant energy at the same flux as solar energy at Earth's surface (1.0 kWᵣ/m²). Assuming that the system is relatively compact, with dish diameter D_{d}=12 meters, D₁=25 centimeters (cm), D_{c}=12.5 centimeters and if the concentrator is 90% effective, the following calculations are obtained.

$$\begin{matrix}Concentrated radiant energy = 0.9 \times PI \times {D}_{d}^{2} / 4 \times 1 {kW}_{r} \text{/} {m}^{2} \\ = 0.9 \times ( 3.14159 ) \times {( 12 m )}^{2} / 4 \times \\ 1 {kW}_{r} \text{/} {m}^{2} \\ = 101.788 {kW}_{r}\end{matrix}$$

$$\begin{matrix}Cavity cross \text{-} sectional area ( {A}_{c} ) = PI \times {( {D}_{c} )}^{2} / 4 \\ = 3.14159 \times {( 12.5 cm )}^{2} \text{/} 4 \\ = 122.72 {cm}^{2}\end{matrix}$$

$$\begin{matrix}Flux at cavity opening = 101.788 {kW}_{r} \text{/} 490.87 {cm}^{2} \\ = 0.82944 {kW}_{r} \text{/} {cm}^{2} \\ = 8294.4 {kW}_{r} \text{/} {m}^{2}\end{matrix}$$

or about 8294 suns. Since parabolic concentrators can obtain fluxes of 10,000 suns or more, this is a reasonable degree of intensification. Further, assuming that the depth, H, of the cavity is 1.0 meters (100 cm), which provides a depth to width ratio of 4:1, we can calculate the average heat transfer flux (Q/A) to the inner pipe's walls, neglecting the end cap of the cavity and assuming an overall absorption of 90% of the incoming radiant energy, as follows:

$$\begin{matrix}Q / A = 0.9 \times 101.788 kW \text{/} [ PI \times {D}_{1} \times H ] \\ = 0.9 \times 101.788 kW \text{/} [ 3.14159 \times 25 cm \times 100 cm ] \\ = 0.011664 kW \text{/} {cm}^{2} \\ = 11.664 watts \text{/} {cm}^{2}\end{matrix}$$

or about 12 watts/cm². This is not an especially challenging heat flux for a microchannel device. Likewise, we can confirm that the heat transfer power density is not overly challenging by assuming an outer diameter (Dₒ), say 27 cm, for the inner pipe. The hardware volume (V) of the inner cylinder and the heat transfer power density (HTPD) are then calculated to be:

$$\begin{matrix}V = PI \times H \times ( {Do}^{2} - {D}_{1}^{2} ) / 4 \\ = 3.14159 \times ( 100 cm ) \times [ {( 27 cm )}^{2} - {( 25 cm )}^{2} ] / 4 \\ = 8168.1 {cm}^{3}\end{matrix}$$

$$\begin{matrix}HTPD = 0.9 \times 101.788 kW \text{/} 8168.1 {cm}^{3} \\ = 0.011215 kW \text{/} {cm}^{3} \\ = 11.215 watts \text{/} {cm}^{3}\end{matrix}$$

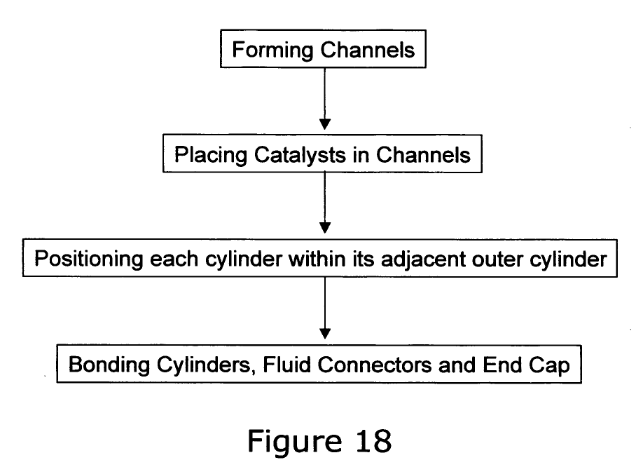

Or about 11 watt/cm³. As noted previously, internal heat fluxes and heat transfer power densities of 10-100 watts/cm² and 10-50 watts/cm³, respectively, are typically achieved through the use of microchannel reactors and heat exchangers. Considering the values of 12 watts/cm² and 11 watts/cm³ obtained through the above calculations, it is clear that it should be possible to operate thermal receivers with embedded microchannels at still higher fluxes of concentrated energy.
Method of Making a Thermal Receiver with Embedded Channels
The preferable sequence for producing a completed thermal receiver consists of: 1) Forming the channels, 2) Placing catalysts in channels where a heterogenous reaction is desired, 3) Positioning each cylinder within its adjacent outer cylinder, and 4) Bonding the cylinders and end-cap together. This process sequence is shown in FIG. 18.

Metals are the preferred materials class for thermal receivers because of the ease with which they may be machined and bonded. However, for cases where higher temperatures are desired than can be accommodated by metals, ceramics are an alternative.

Channels for use in a thermal receiver can be formed in a number of ways. For receivers that are made of up cylindrical units, the channels are preferably formed before the cylinders are brought together. For example, channels can be formed on the outer surface of a metal cylinder through multiple machining techniques, depending upon the desired dimensions of the channels, including the use of a slitting saw, or alternately through the use of electro-discharge machining or electrochemical machining, which each produce cuts with their own unique characteristics. For example, a ten-mill-thick blade operated in a slitting saw can produce a channel that is about 250 microns wide at depths up to a centimeter, and it is a relatively simple thing to configure the blade(s) so that the walls between the channels are likewise 250 microns in width.

As previously mentioned, the channels that are required on the inner walls of a cylinder typically operate as headers and footers are therefore preferably fewer in number and larger in cross-section. Accordingly, a rotary or linear cutting tool can be applied to produce these channels. However, other methods can also be applied, again such as through the application of electro-discharging and electrochemical machining techniques.

If a ceramic material is to be used, the channels can be formed through an embossing process prior to the firing of the ceramic. Alternately, channels may be formed as part of the extrusion process that creates metal or ceramic cylinders.

Catalysts can be placed in channels via multiple methods as well that are well known to those skilled in the art. Wet-coating is preferred in some cases where the catalysts are to be applied to the inner surface of the channels, but various vapor-deposition processes can also be applied. Alternately, catalysts can be placed in the channels as an insert.

Preferably, the cylinders have been chosen so that they fit within each other with little or no gap between. If the material of choice is a metal, heat may be applied at step 3); thermal expansion increases the diameter of the heat cylinder(s), so that they may more readily be fit to the inner counterparts. In this way, it is possible to fit a metal cylinder inside another where there would otherwise be no gap (i.e., where the outer diameter of the inner cylinder is essentially equal to the inner diameter of the outer cylinder). This creates a tight fit that may not require additional bonding to reduce the potential of leakage.

The fourth step involves bonding the cylinders and end-cap together. When bonding is required for metal cylinders, the preferred method is to create a weld along the ends of the cylinders. This weld can be applied using classical welding techniques that are well known to those that are skilled in the art. Alternate welding methods can include laser welding or friction stir welding, which may be quicker and which therefore may provide cost advantages. Where ceramic or other materials are involved that do not enable welding, seams with sealing materials are preferred.

### Other Components

Other components that are not described but which are nevertheless important elements within the invention include pumps, valves, blowers, fans, compressors, electronics, sensors, actuators (motors) and other various items that are needed to motivate and/or control fluids and structures and other portions of the invention(s).

### Functional Operation

Three example classes of operation are discussed below, for applications on Mars, the Moon and Earth.

### EXAMPLE 1

### The Invention(s) When Operated for the Production of Propellants and Other Chemicals on the Surface of Mars

Plans for the exploration of Mars include the production of propellants and other chemicals using feedstock materials from the Martian atmosphere. For example, the document, “Human Exploration of Mars: The Reference Mission of the NASA Mars Exploration Study Team” (NASA Special Publiction 6107), presents a preliminary description of a propellant production plant that produces 5.8 metric tones (MT) of methane (CH₄) and 20.2 MT of oxygen (O₂), to be used as propellant for the return of humans to Earth. The feedstocks for this are carbon dioxide (CO₂) and hydrogen (H₂). Methane is described as being produced through the use of the exothermic Sabatier Process Reaction:

CO₂+3H₂→CH₄+H₂O,

and oxygen can be produced by two alternative processes, water electrolysis and CO₂ electrolysis. More recently, the Reverse Water Gas Shift (RWGS) reaction has been identified as an alternative to the CO₂ electrolysis step. The RWGS reaction is endothermic in nature and is as follows:

CO₂+H₂+CO+H₂O

Since the amount of “equilibrium conversion” of CO₂ into CO, in the endothermic RWGS reaction, is directly proportional to temperature—higher temperatures result in more CO—high temperature heat is desirable. This makes the RWGS reaction a good candidate for the concept of using concentrated radiant energy in support of thermochemical processing. On Mars, energy for the reaction would be provided by configuring a RWGS microchannel reactor as part of a thermal receiver such as in FIG. 3. An intermediate, recuperative microchannel heat exchanger would also preferably be used to cool the products of the reaction, giving up their heat to preheat the reactants.

An alternative approach involves starting the RWGS reaction out at a low temperature while heating the reacting stream to a higher temperature as the reaction proceeds in what is called a “differential temperature microchannel reactor”. This concept, which makes more efficient use of the energy needed for the reaction, has also been demonstrated at PNNL. See U.S. Pat. No. 7,297,324, TeGrotenhuis, W., et. al., “Microchannel reactors with temperature control”, 2007.

Thermochemical processing is also relevant for capturing and compressing CO₂ from the martian atmosphere. For example, absorption and adsorption methods have been examined. In each case, heat is generated during the sorption process and must ultimately be rejected to the martian atmosphere. Also, heat must be added to desorb CO₂ from the sorption media. Since the temperatures required for the desorption steps are at most moderate, the efficiency of this system operation is highest if the sorption process is thermally integrated with other thermal process units, such as through the use of heat from a moderate temperature exothermic reaction (e.g., the Sebatier Process Reaction) to provide heat for desorption. Finally, thermochemical water-splitting, which will be highlighted in the following example, is another alternative thermochemical process that is relevant for the Mars application. Here, heat is supplied to a network of reactors, heat exchangers and separators for the purpose of producing H₂ and O₂ from water. It is therefore an alternative to water electrolysis.

### EXAMPLE 2

### The Invention(S) when Operated for the Production of Propellants and Other Chemicals on the Lunar Surface

Data from the Lunar Prospector and Clementine missions suggest that water (and perhaps other volatiles) is present in cold traps on the lunar surface, in the vicinity of the north and south poles of the Moon. Upon confirmation, it is anticipated that lunar water will be used as feedstocks for producing oxygen and oxygen-fuel propellant mixes for future human missions to the Moon.

Based on an assumption of two missions per year, lunar outposts are expected to require about 8-10 MT of oxygen per year. Hydrogen and oxygen can be produced from lunar water through electrolysis, or alternately, through the use of a thermochemical water-splitting process, such as any number of such processes that are currently under investigation for terrestrial applications. These include but are not limited to the following listing:
Zinc oxide process
Cadmium carbonate process
Sodium manganese process
Iron oxide process
Hybrid copper chloride process
Sulfur iodine process
Hybrid sulfur process
Calcium-iron bromide-2 process (also known as the UT-3 cycle)

See Steinfeld, A., “Solar Thermochemical Production of Hydrogen—A Review”, Solar Energy 78 (2005) 603-615.

Energy for the thermochemical production of hydrogen and oxygen from water can be provided by directing radiant energy onto or through a concentrator, which reflects and/or focuses the energy onto a thermal receiver where the majority of the photons are absorbed, producing heat. This heat is either used a) to directly heat a unit that performs an endothermic chemical process, b) to directly heat a fluid stream, containing chemicals that are to be subsequently processed in a unit performing an endothermic chemical process, or c) to heat a separate heat transfer fluid, which provides heat to a unit that performs an endothermic chemical process.

As mentioned previously, uncertainty currently exists regarding the form and composition of volatiles that may be present in the lunar cold traps. If volatiles other than water are present, as may be the case particularly if comet impacts are a source of the volatiles, then other compounds that may be present include hydrocarbons, carbon dioxide, carbon monoxide and ammonia, each of which would be present as ices. Accordingly, there may be many other options for space-resource-based-chemical products on the Moon that could make use of the invention(s) described herein.

For example, if carbon dioxide is present, it could be reacted with hydrogen (produced from water using electrolysis or a thermochemical water-splitting process) via either the endothermic RWGS reaction or the exothermic Sebatier Process Reaction, each of which was discussed previously. Methane, from the Sebatier Process Reaction, could be used directly as rocket fuel. Alternative potential fuels that could be produced, which are more readily storable than hydrogen or methane, include alcohols (e.g., methanol or ethanol which could be produced in appropriate synthesis reactors) and longer-chain hydrocarbons (which could for example be produced in a Fischer-Tropsch process reactor).

Finally, for logistics reasons, it may be desirable to locate the chemical processing hardware within a “cold trap” on the lunar surface, such as within a deep crater near either the north or south poles of the Moon. In this case, it may also be appropriate to consider beaming power into the crater either from a location on the surface, such as the crater rim, or from a location in space, such as a powersat in a polar lunar orbit. For the former case, the original energy source may be photovoltaics or another form of solar energy conversion or it may be another source such as a nuclear reactor. With regard to the latter case, although it may seem difficult to contemplate beaming power from an orbiter, it is noted that the cost of placing hardware in lunar orbit is considerably less than placing hardware on the lunar surface. This is moreso true with the Moon than with Mars, where there is an atmosphere for aerobraking.

### EXAMPLE 3

### The Invention(s) when Operated for the Production of Chemicals on Earth

Terrestrial applications encounter a different cost dynamic than applications on planetary bodies. As opposed to the lunar case, where it is less expensive to place hardware mass in orbit than on the surface, for applications on Earth it is generally less expensive to retain hardware on the surface than place it in orbit. However, there are still instances where orbiting systems may provide substantial cost advantages.

For terrestrial applications, the inventions described herein consist of surface installations, where the concentrators, thermal receivers and thermochemical processor systems are located. In one preferred embodiment, the system consists of a segmented-mirror, parabolic dish concentrator that tracks the sun during the daytime, delivering 100 kWᵣ (kilowatts of radiant energy) to the thermal receiver. Portions of the thermochemical processor, located at or in close proximity to the focal point of the concentrator, use the heat to support moderate- to high-temperature, endothermic chemical operations. During the portion of the day when the sun is unavailable, such as during the nighttime, the system may also track a powersat transmitter that redirects/reflects sunlight to the concentrator or that beams radiant energy to the ground facility.

Most preferably, the powersat transmits microwave energy to the surface installation. In an alternative embodiment, the surface facility tracks and receives energy only from the powersat.

An example of a system that could be commercially viable in the near-term is one that produces hydrogen from natural gas. Here, the concentrators provide the high temperature heat that is necessary to support an endothermic steam reforming operation within the thermal receiver, converting methane and steam to synthesis gas. The generalized equation for methane steam reforming is:

CH₄+H₂O→3H₂+CO

Note however that this equation assumes complete conversion of carbon to carbon monoxide; in reality, carbon dioxide will also be formed, so a greater proportion of water is needed than the equation implies in order to approach complete conversion of methane. A thermal receiver, performing the steam reforming reaction within embedded microchannels, should be able to obtain a component thermochemical efficiency of at least 40%, and may be able to reach in excess of 60%.

Downstream separations, such as using a palladium membrane, can provide purification of the product stream. Other reactors in the system, also downstream of the reforming reactor, could perform the water-gas-shift reaction,

CO+H₂O→CO₂+H₂

which further converts steam and carbon dioxide to additional hydrogen and carbon dioxide. Networks of this sort should obtain reasonable thermochemical efficiencies, in excess of 30%, if the reactors, heat exchangers, and separators are integrated into an efficient thermochemical processing system.

Other useful chemical products are possible. For example, a modification to the system that processes natural gas would enable the production of ammonia, a chemical that is useful in agricultural markets, or alternative liquid hydrocarbon fuels such as methanol or long-chain hydrocarbons (via the Fischer-Tropsch process reaction).

It is also possible to use radiant energy thermochemical processing to produce hydrocarbons using water and atmospheric carbon dioxide as feedstocks. For example, hydrogen could be produced using a thermochemical water-splitting process and carbon dioxide can be extracted from the atmosphere using an endothermic sorption process. A high-temperature, reverse-water-gas shift reaction, receiving solar energy as its heat source, would produce carbon monoxide from hydrogen and carbon dioxide. If an excess of hydrogen is used, higher conversions are obtained and the resulting product (synthesis gas) can then be converted to methanol, Fischer-Tropsch long-chain hydrocarbons, or other useful products.

As discussed above for the Mars and Moon applications, the capacity factor for the ground-based systems can be increased through the utilization of orbiting assets, such as powersats that reflect/redirect solar energy or beam microwaves or laser energy to the ground system. The concept that is contemplated is an alternative to historical proposals for space-solar power, which have typically focused on producing power for the terrestrial electricity market. Usually the orbiting unit converts solar energy to microwave or laser energy, beaming photons to ground-based receivers (rectifying attennas or photovoltaics) which produce electricity.

Alternately, to support the production of energy fuels and other chemicals, the beam from a powersat can be used to support thermochemical processing. Since the orbiting units can direct energy to radiant energy receivers at any time of day (or night), the capacity factor of the ground facility is increased without a net increase in the capital cost of the ground facility. The marginal cost is the cost of establishing and operating the orbiting systems.

To maximize value, the ground facility might utilize solar energy from the sun when it is available while also utilizing other radiant energy from one or more powersats. Capacity factors could conceivably be increased from a value of about 20%-25%, if only the sun is tracked, to double or triple that, or even higher, depending upon environmental (e.g., the need to maintain diurnal conditions) or other factors.

With multiple facilities located around the world, powersats could provide energy throughout the day by directing their output first to one terrestrial system, then to others, or to other applications, as they orbit. Other applications could include providing radiant energy to rectenna systems or providing radiant energy to heat or otherwise support agricultural areas, supplementing solar energy in support of crop growth or providing heat for crops that were in danger of frost. Thus, the capital, operating and maintenance costs associated with the orbiting assets could be amortized amongst multiple applications.

### Preliminary Calculation for Human Missions to Mars

The amount of solar or other radiant energy that is needed for the thermochemical process depends in part on the efficiency with which the process is operated. We can realistically expect that the efficiency of the overall process, including the component efficiencies of the concentrator and thermal receiver units and all thermochemical unit operations, will typically be in the range of about 20%-40%. With this in mind, an example calculation was performed that estimates the amount of required energy based upon an assumption that the thermochemical process system operates with a thermochemical efficiency of about 25%.

The example calculation also notes that 5.8 metric tones (MT) of methane is desired and that methane has an energy content of about 15.42 kWh per kg (kilowatt-hours of chemical energy per kilogram), based on the higher heating value of methane). Then the total amount of energy required by the system to produce the methane product is:

$$\begin{matrix}Thermal Energy Required = 5.8 MT \times ( 15.42 kWh \text{/} kg ) \times \\ ( {10}^{3} kg \text{/} MT ) / 0.25 \\ = 3.58 \times {10}^{5} {kWh}_{t}\end{matrix}$$

where kWhₜ represents kilowatt-hours of thermal energy. The approximate size of the concentrator can be estimated by assuming that the system operates, due to a diurnal effect, with a capacity factor of 25% for one Earth year (8760 hours). Assuming that direct solar energy is the input, then noting that the solar flux at Mars is about half that at Earth's surface, or about 500 W/m², we can estimate the size of a solar concentrator to be:

$$\begin{matrix}Area = 3.58 \times {10}^{5} kWh \times \\ {10}^{3} w \text{/} kW \text{/} 0.25 \text{/} ( 500 w \text{/} {m}^{2} ) / ( 8760 hours ) \\ = 81.7 {m}^{2}\end{matrix}$$

$$\begin{matrix}Radius = SQRT [ 1.7 {m}^{2} \text{/} 3.14159 ] \\ = 5.1 meters\end{matrix}$$

At this size, it is clear that a parabolic mirror concentrator approach could be applied.

Assuming that a powersat would have an orbital period of one Mars day, and that the powerbeam would have a power density at Mars' surface that is equal to the solar energy power density at Mars, the thermochemical process system would have to operate at only the rate required for the system that uses direct solar only.

Therefore, the hardware volume and mass for the thermochemical process system is also reduced by a factor of about 4.

Note that this calculation was a Rough-Order-of-Magnitude (ROM) calculation. Significant uncertainties include seasonal effects, such as martian duststorms, the efficiency of the thermochemical process system and the flux at the surface of Mars from an orbiting transmitter. However, the calculation still provides insights on the approximate size (again, ROM) for a radiant-energy-powered thermochemical processing plant that produces methane and oxygen on Mars.

### Preliminary Calculations for Mars Robotic Sample Return Mission

Similar calculations can be performed for robotic missions to Mars assuming that we need, say, about 200 kg of methane. For this calculation we will further assume that a radioisotope thermoelectric generator will be brought along and that it can provide heat for low- to moderate-temperature endothermic operations; therefore the concentrator must only provide heat for the high-temperature operations. Thus for this example calculation we are only interested in using solar energy as a source of high temperature heat for the endothermic RWGS reaction.

Calculations can be performed that show that for every kilogram of CH₄ to be produced about 3.2 kilograms (114.3 moles) of CO must ideally also be produced. Thus, the required production of CO is about 640 kg (22,860 moles). The endothermic energy requirement for the RWGS reaction is about 41 kJ/mole (CO), where kJ represents “kilojoules”. Based upon this, an assumption that the overall efficiency of the process is 25%, and using the same calculation method as in the previous example, we calculate the thermal energy requirement to be:

$$\begin{matrix}Thermal Energy Required = 22860 moles \times 41 kJ \text{/} mole \text{/} 0.25 \\ = 2749 MJ\end{matrix}$$

where MJ represents megajoules (i.e., 1,000 kJ). This is equivalent to about 1041 kWh.

Assuming that the mission involves a stay on the martian surface of only 90 days and that the capacity factor for the concentrator/chemical processor is only 25%, we calculate the required concentrator area and radius to be:

$$\begin{matrix}Area = 1041 kWh \times ( 1000 w \text{/} kWh ) \text{/} 0.25 \text{/} ( 500 w \text{/} {m}^{2} ) \text{/} 2160 hours \\ = 3.86 {m}^{2}\end{matrix}$$

$$\begin{matrix}Radius = SQRT [ 3.86 {m}^{2} \text{/} 3.14159 ] \\ = 1.11 meters\end{matrix}$$

This implies that we need a concentrator with a radius of about 3.6 feet.

This value is already quite small; while an orbiting asset such as a powersat could allow the required concentrator area to decrease, a better advantage might be that the orbiting asset allows the system to produce the required amount of propellant in about of the time, e.g., about 22-23 days.

### Preliminary Calculation for Lunar Propellant Production

As mentioned previously, lunar outposts are expected to require about 8-10 MT of oxygen per year, based on the assumption of two manned missions to the Moon each year. Assuming that water ice is found in polar regions, we can calculate the energy requirements and the concentrator area and radius by noting that hydrogen has a higher heating value of about 142.1 MJ/kg and that the process that produces O₂ from water will also produce about 2 kg of H₂ for each 16 kg of O₂. For the case where direct solar is used for thermochemical water-splitting, as discussed previously, with an assumption that the overall process is 25% efficient we calculate the thermal energy requirement to be:

$$\begin{matrix}Thermal Energy Required = 10 MT {O}_{2} \times 1000 kg \text{/} MT \times \\ ( 2 \text{/} 16 kg {H}_{2} \text{/} kg {O}_{2} ) \times \\ 142.1 MJ \text{/} kg {H}_{2} \\ = 7.105 \times {10}^{5} MJ\end{matrix}$$

For the concentrator area and radius, we note that the solar flux at the Moon is 1360 W/m², then assuming capacity factor of 25%:

$$\begin{matrix}Area = 7.105 \times {10}^{5} MJ \times \\ ( 1000 Wh \text{/} 3.6 MJ ) \text{/} 0.25 \text{/} ( 1360 W \text{/} {m}^{2} ) \text{/} 8760 hours \\ = 66.26 {m}^{2}\end{matrix}$$

$$\begin{matrix}Radius = SQRT [ 66.26 {m}^{2} / 3.14159 ] \\ = 4.59 meters\end{matrix}$$

This is a large structure, compared to the previous calculation for Mars; however, it is not necessarily of large mass. On the Moon, the lack of an atmosphere means that there is no wind loading and of course gravity is only ⅙^{th} g. Therefore, thin-film mirrors with inflatable structures may be an option for the concentrating structure, and it is clear that options include a parabolic mirror and/or a central receiver with heliostat mirrors. At kg per m² for thin film materials, the approximate mass for the concentrator alone would be about 44 kg, and since it will probably cost about 50,000 US dollars (or more) per kg to deliver a payload to the Moon, the cost of delivering: the concentrator is in the neighborhood of 1.65 million US dollars. This is undoubtedly less than the development cost for the unit.

In addition, we can consider the case where photovoltaics are used to convert solar energy to electricity which is then used to support electrolysis. Assuming that the photovoltaics are between 10% and 20% efficient, and that the electrolysis process is 50% efficient, we estimate an overall efficiency of 5% to 10%. Further assuming that the photovoltaic power system is able to track the sun, with the same capacity factor as the concentrators for the thermochemical process, one can calculate that the total area require for the photovoltaics is about 165 m² to 330 m².

Alternately, we can also calculate the approximate size of the concentrator if the system includes orbiting transmitters, such as a powersat parked at the L1 Lagrangian Point directly between the Earth and the Moon, converting solar energy to microwaves or laser power. Assuming the same flux on the lunar surface, but increasing the capacity factor to 100%, we calculate the area and radius to be 16.6 m² and 2.30 meters, respectively. This is small enough that a parabolic mirror structure may be appropriate.

As before, one of the primary advantages of making use of one or more powersats would be the ability to reduce the hardware mass for what must be landed on the lunar surface. While the mass of the concentrator is relatively small, the chemical processor is substantially more massive. Operating with a capacity factor of 1000% would shrink this mass by about a factor of 4.

We can estimate the difference in chemical process hardware mass for the lunar surface application by noting the difference in power rate for the two cases: 90.1 kW and 22.5 kW, for the two cases with and without the powersat, respectively. Using the assumption that the thermochemical process system will be a network of conventional chemical process technology, and assuming that the portions of the system that are dominated by thermal effects have a net heat transport power density of about 0.1 w/cm³ and a hardware density of about 5 grams/cm³, then we can calculate the hardware mass for each case to be, respectively, about 4500 kg and about 1125 kg; i.e., the powersat allows a reduction in hardware mass of about 3375 kg. Again, working with an assumption that each kg of mass to be landed on the Moon costs about 50,000 US dollars, the gross savings associated with the reduction in hardware mass is estimated to be about 168.8 million US dollars, which may be of the same order of magnitude as the cost of the powersat. Note again that these numbers are extremely preliminary; considering that we did not consider major portions of the process system, such as regolith excavation and volatiles extraction, it is probably more appropriate to consider the cost reduction to be in the range of 100 million to one billion US dollars.

### Preliminary Calculation for Terrestrial Applications

Extensive calculations have been performed comparing various chemical feedstocks and operating scenarios for terrestrial applications. These calculations, which have been based upon limiting features of the various chemical processes, such as the amount of highly concentrated radiant energy (for endothermic chemical reactions) and the conversion and selectivity of low- to moderate-temperature exothermic reactions, provide estimates of the potential advantages of a facility that produces solar fuels.

Consider a thermochemical facility with sufficient numbers of concentrators such that, during periods of bright sunlight, cumulative solar energy rates of 1.0 GWₛ would be used to drive high-temperature, endothermic chemical reactions. A system based on parabolic dish concentrators at 100 kWₛ each would require 10,000 dishes to yield a cumulative energy of 1.0 GWₛ; alternately, a system based on central receiver towers with beam-down optics at 50,000 kWₛ each would require 20 tower systems.

For these productivity calculations, it is also assumed that the thermochemical efficiency of the concentrator-receiver-endothermic reactor combination is 40% (except for thermochemical water-splitting where we selected a range of 30-50%). In addition, it is assumed that the thermal energy for low- to moderate-temperature operations such as water vaporization, thermal-swing separations, and distillation, are provided in part through thermal integration with exothermic unit operations and in part through the use of less expensive, parabolic trough concentrators.

For the calculations, three classes of chemical feedstocks were assumed: Methane (based on natural gas as the feedstock source); methane plus carbon dioxide (based upon the typical products of the anaerobic digestion of biomass); and water and water plus carbon dioxide (as zero-energy chemicals); however, other chemical feedstocks could also be used. Various appropriate assumptions were also made about the yields of downstream reactors and separators, with the specific calculations assuming that the solar fuels to be produced were hydrogen and/or a long-chain hydrocarbon (i.e., through the Fischer-Tropsch reaction).

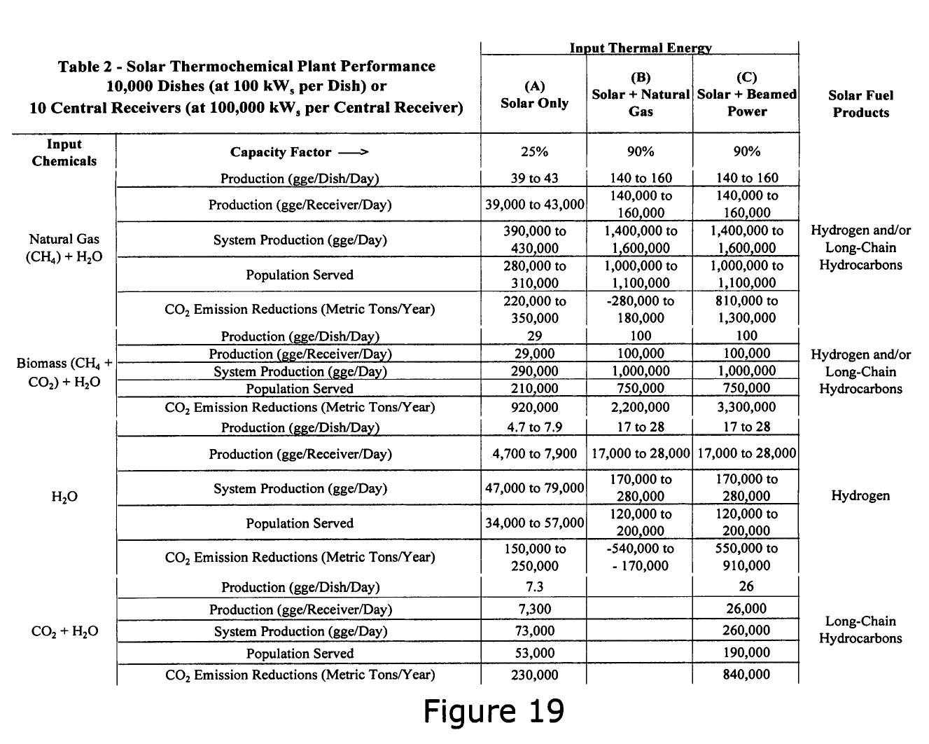

Results of the calculations are presented in FIG. 19. In Column (A) of FIG. 19, we consider the thermochemical facility when operated when the sun is available, achieving in this case an average capacity factor of 25%. This is equivalent to full production for six hours per day, 365 days per year. If natural gas is used as a feedstock, the output of the facility is estimated to be 390,000 to 430,000 gallons of gasoline equivalent per day (gge/day). Based on current gasoline usage in the US, this production rate would serve the transportation needs of about 280,000 to 310,000 people. Alternately, if biomass materials or zero-energy feedstocks, such as water and/or carbon dioxide are used, the productivity of the facility is reduced due to the reduced chemical energy content of the reactants.

Columns (B) and (C) consider operational scenarios where the thermochemical facility is operated with a higher capacity factor than can be afforded with direct solar energy only. In Column (B), it is assumed that natural gas is combusted to bring increase the capacity factor by 65%, bringing the overall capacity factor of the facility to 90%; and in Column (C) it is assumed that a powerbeam from an orbiting facility brings the overall capacity factor to 90%. The latter could be achieved by using solar energy plus the powerbeam or by just using the powerbeam. Of course, other combinations of energy sources and operational scenarios are also possible as ways to increase the overall capacity factor of the thermochemical facility.

When the facility is operated with an overall capacity factor of 90%, the productivity of the facility increases proportionally. For example, in the case where natural gas is used as the chemical feedstock, the facility's daily production when operated at a capacity factor of 90% is estimated to be about 1,400,000 to 1,600,000 gge/day, enough to serve the transportation needs for a US population of about 1.0 to 1.1 million.

Calculations also show a potential for the reduction in greenhouse gas emissions. For example, we note that the combustion of one gallon of gasoline, on the average, results in the release of 8.82 kg of carbon dioxide. For the same net chemical energy production (based on the higher heating values of gasoline and methane), the combustion of natural gas would generate only about 6.67 kg of carbon dioxide; accordingly, displacing gasoline with solar fuels derived from natural gas should generally reduce carbon dioxide emissions. However, the actual releases will depend upon the source of the thermal energy that is used in the thermochemical facility.

Accordingly, FIG. 19 includes estimates of the greenhouse gas emissions (increases and reductions) associated with the operation of the reference thermochemical facility. For cases where only solar energy is used to support the endothermic chemical reactions, for example, Column (A), net carbon dioxide emissions are reduced (compared to using gasoline as a transportation fuel). However, when natural gas is burned to support the endothermic chemical reactions, as in Column (B), mixed results occur. If natural gas is also used as the feedstock chemical for the reaction, net carbon dioxide emissions are increased.

The best case for greenhouse gas emission reductions occurs when biomass feedstocks are combined with a carbon-neutral energy source, such as beamed, radiant energy from a powersat. In this case, the biomass feedstock brings carbon-neutral, chemical energy content and the powersat supports increased capacity factor for the thermochemical facility. The productivity of the facility as well as its emissions will depend of course upon the capacity factor of the facility and therefore is also dependent upon the power density of the radiant energy beam; for calculations where the capacity factor is assumed to be 90%, approximately 1,000,000 gge/day is produced (equivalent to about 0.24% of the USA's annual oil imports) and carbon dioxide emissions are reduced by 3,300,000 metric tonnes per year. Forty such facilities, each occupying a few square kilometers could reduce USA oil imports by nearly 10%.

### CLOSURE

While preferred embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A space solar power system comprising
a. a transmitter,
b. a concentrator, and
c. a radiant energy receiver further comprising a heat exchanger
whereby a powerbeam is directed from said transmitter to said concentrator, said concentrator intensifies and directs said powerbeam to said radiant energy receiver, and said radiant energy receiver converts said powerbeam into heat and an increase in the energy content of a fluid.

2. The space solar power system of claim 1 wherein said concentrator further comprises
a. a first segment that intensifies radiant energy at visible light wavelengths and
b. a second segment that intensifies radiant energy at microwave wavelengths
wherein said second segment has an average pore size of at least one millimeter.

3. The space solar power system of claim 2 wherein said second segment has an average pore size of at least five millimeters.

4. The space solar power system of claim 1 wherein said heat exchanger is a microchannel heat exchanger.

5. The space solar power system of claim 4 wherein said microchannel heat exchanger further comprises a catalyst for an endothermic reaction.

6. The space solar power system of claim 1 wherein said powerbeam is in a form selected from the group consisting of: laser energy, microwaves, or millimeter waves.

7. The space solar power system of claim 1 wherein said transmitter is part of a system located at a powersat or on a lunar or planetary surface.

8. A space solar power system comprising
a. a powersat, producing a powerbeam,
b. a first plurality of surface structures on a lunar or planetary surface, further comprising receivers for the production of electricity,
c. a second plurality of surface structures on said lunar or planetary surface, further comprising concentrators and receivers for increasing the chemical energy content of a reacting fluid through an endothermic chemical reaction, and
d. means to adjust said powerbeam to vary the surface flux at said first plurality of surface structures and said second plurality of surface structures.

9. The space solar power system of claim 8 wherein said powerbeam initially provides a higher power density to said first plurality of surface structures for a first period of time and then adjusted to provide a higher power density to said second plurality of surface structures for a second period of time.

10. The space solar power system of claim 9 wherein said second plurality of surface structures is operated using solar energy during said first period of time.

11. The space solar power system of claim 8 wherein said receivers further comprise nested cylinders incorporating manifolds, heat exchange zones, and reaction zones.

12. A method of operating a space solar power system comprising
a. a first step of directing a powerbeam from a transmitter to a first portion of a surface installation and producing electricity while utilizing solar energy to perform a thermochemical process in a second portion of said surface installation, and
b. a second step of adjusting the powerbeam to provide radiant energy to said second portion of said surface installation thereby providing powerbeam energy for said thermochemical process.

13. The method of operating a space solar power system of claim 12 wherein a portion of said powerbeam is also directed to said first surface installation during said second step.

14. The method of operating a space solar power system of claim 12 wherein said second step additionally comprises adjusting said powerbeam so that both said first surface installation and said second surface installation receive said powerbeam.

15. A method of operating a radiant energy concentrator comprising
a. aligning said concentrator with, and receiving radiant energy from, a first source of radiant energy during a portion of time, directing intensified radiant energy into a receiver, converting it to heat, and performing an endothermic chemical reaction, and
b. aligning said concentrator with, and receiving and radiant energy from, a second source of radiant energy during a portion of time, directing intensified radiant energy into said receiver, converting it to heat, and performing said endothermic chemical reaction.

16. The method of operating a radiant energy concentrator of claim 15 wherein said first source of radiant energy is the sun.

17. The method of operating a radiant energy concentrator of claim 15 wherein said second source of radiant energy is a powersat.

18. The method of operating a radiant energy concentrator of claim 17 further comprising producing energy at said powersat in a form selected from the group consisting of: laser energy, microwaves, and millimeter waves.

19. The method of operating a radiant energy concentrator of claim 15 further comprising providing supplemental heat to said endothermic chemical reaction.

20. The method of operating a radiant energy concentrator of claim 19 wherein the source of supplemental heat is selected from the group consisting of: a combustion reaction, a non-combustion exothermic reaction, and an electrical resistance heater.
